(19) United States
(12) Patent Application Publication
(10) Pub. No.: US 2026/0173125 A1
(43) Pub. Date: Jun. 18, 2026

(54) ELECTRONIC DEVICE, METHOD AND STORAGE MEDIUM FOR MODEL INFERENCE

(71) Applicant: Sony Group Corporation, Tokyo (JP)

(72) Inventors: Wei CHEN, Beijing (CN); Yuanrui LIU, Beijing (CN); Ce ZHENG, Beijing (CN); Chen SUN, Beijing (CN)

(73) Assignee: Sony Group Corporation, Tokyo (JP)

(21) Appl. No.: 19/129,315

(22) PCT Filed: Nov. 24, 2023
(86) PCT No.: PCT/CN2023/133909

§ 371 Date: May 13, 2025

(30) Foreign Application Priority Data
Nov. 28, 2022 (CN) 202211502760.3

(51) Int. Cl. H04W 72/53; H04L 41/16

(52) U.S. Cl. CPC H04W 72/53; H04L 41/16

(57) ABSTRACT

The present disclosure relates to an electronic device, a method and a storage medium for model inference. Embodiments for AI/ML model inference are described. In an embodiment, the electronic device comprises a processing circuit configured to: form split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and based on the split information, cause a wireless network to allocate to at least one of the plurality of participant devices resources for transmitting model inference information.

### TECHNICAL FIELD

The present disclosure generally relates to wireless communication systems and methods, including technologies for performing artificial intelligence (AI)/machine learning (ML) model inference in wireless communication systems.

### BACKGROUND

AI/ML technologies are being applied in a variety of industries across a wide range of applications, significantly enhancing productivity. For example, in the wireless communication system, mobile devices (such as smartphones, smart cars, drones, and mobile robots) are increasingly using AI/ML models to replace traditional algorithms (such as speech recognition, machine translation, image recognition, video processing, and user behavior prediction) to enable various applications. Examples of these applications include augmented photography, smart personal assistants, VR/AR, video games, video analysis, personalized shopping recommendations, autonomous driving/navigation, smart home appliances, mobile robotics, mobile healthcare, and mobile finance.

AI/ML models can be trained, and the trained AI/ML models can be used for model inference for specific AI/ML tasks. During model inference, input from the real world is passed through the AI/ML model, and the prediction for the task is output. For example, the input can be pixels of an image or sampling amplitudes of an audio wave. Accordingly, the output of the AI/ML model can be a probability that the image contains a specific object or a probability that an audio sequence contains a specific word. It should be understood that a result of model inference is related to complexity of the AI/ML model and the complexity of the AI/ML model in turn relates to resources consumed by the model inference.

### SUMMARY

A first aspect of the present disclosure relates to a method for model inference in a wireless communication system, including: determining an AI/ML model corresponding to an AI/ML task of a first terminal device; forming split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and based on the split information, causing a wireless network to allocate to at least one of the plurality of participant devices resources for transmitting model inference information. The first aspect of the present disclosure further relates to an electronic device. The electronic device includes a processing circuit configured to perform the method according to the first aspect. In an embodiment, the electronic device can be used for a terminal device or a network endpoint.

A second aspect of the present disclosure relates to a method for model inference in a wireless communication system, including: obtaining split information for at least a first part of an AI/ML model, where the AI/ML model corresponds to an AI/ML task of a first terminal device, and the split information specifies that split model inference is to be performed by a plurality of participant devices on a plurality of subparts of at least the first part of the AI/ML model; and based on the split information, allocating to at least one of the plurality of participant devices resources for transmitting the model inference information. The second aspect of the present disclosure further relates to an electronic device for a base station. The electronic device includes a processing circuit configured to perform the method according to the second aspect.

A third aspect of the present disclosure relates to a method for model inference in a wireless communication system, including: receiving an instruction for performing model inference from a first terminal device, the instruction including indication information for a respective subpart of an AI/ML model and indication information for a downstream participant device; receiving resource allocation for transmitting model inference information, the resource allocation indicating resources for radio links with an upstream participant device and the downstream participant device; based on the instruction and the resource allocation, receiving first intermediate data from the upstream participant device via the radio link with the upstream participant device; inputting first intermediate data into the respective subpart of the AI/ML model to obtain second intermediate data; and based on the instruction and the resource allocation, transmitting second intermediate data to the downstream participant device via the radio link with the downstream participant device. The third aspect of the present disclosure further relates to an electronic device for a terminal device. The electronic device includes a processing circuit configured to perform the method according to the third aspect.

A fourth aspect of the present disclosure relates to a computer-readable storage medium storing executable instructions stored thereon which, when executed by one or more processors, implement operations of the method according to various embodiments in the present disclosure.

A fifth aspect of the present disclosure relates to a computer program product including instructions which, when executed by a computer, cause implementation of the method according to various embodiments in the present disclosure.

The above summary is provided to summarize some exemplary embodiments in order to provide a basic understanding of the various aspects of the subject matter described herein. Therefore, the above-described features are merely examples and should not be construed as limiting the scope or spirit of the subject matter described herein in any way. Other features, aspects, and advantages of the subject matter described herein will become apparent from the Detailed Description described below in conjunction with the drawings.

### BRIEF DESCRIPTION OF DRAWINGS

A better understanding of the present disclosure can be achieved by referring to the detailed description given hereinafter in connection with the accompanying drawings. The same or similar reference numerals are used in the accompanying drawings to denote the same or similar components. The accompanying drawings together with the following detailed description are included in the specification and form a part of the specification, and are used to exemplify the embodiments of the present disclosure and explain the principles and advantages of the present disclosure, where:

FIG. 1 illustrates an example block diagram of a communication system according to an embodiment of the present disclosure.

FIG. 2A illustrates an example of an AI/ML model according to an embodiment of the present disclosure.

FIG. 2B illustrates an example of a split AI/ML model according to an embodiment of the present disclosure.

FIG. 3A illustrates an exemplary electronic device for a terminal device or a network endpoint according to an embodiment of the present disclosure.

FIG. 3B illustrates an exemplary electronic device for a terminal device according to an embodiment of the present disclosure.

FIG. 3C illustrates an exemplary electronic device for a base station according to an embodiment of the present disclosure.

FIG. 3D to FIG. 3F illustrate exemplary procedures for split model inference according to an embodiment of the present disclosure.

FIG. 4 illustrates an exemplary operation for splitting an AI/ML model according to an embodiment of the present disclosure.

FIG. 5A and FIG. 5B illustrate examples of split AI/ML models according to an embodiment of the present disclosure.

FIG. 6A to FIG. 6C illustrate examples of split information according to an embodiment of the present disclosure.

FIG. 7A and FIG. 7B illustrate exemplary operations for distributing split information according to an embodiment of the present disclosure.

FIG. 8A to FIG. 8D illustrate exemplary operations for performing split model inference according to an embodiment of the present disclosure.

FIG. 9A illustrates an example signaling flow for allocating transmission resources to participant devices for model inference according to an embodiment of the present disclosure.

FIG. 9B illustrates an example operation for allocating transmission resources to participant devices for model inference according to an embodiment of the present disclosure.

FIG. 10 illustrates an example method for resource allocation in model inference according to an embodiment of the present disclosure.

FIG. 11 illustrates an example method for resource allocation in model inference according to an embodiment of the present disclosure.

FIG. 12 illustrates an example method for model inference according to an embodiment of the present disclosure.

FIG. 13 is an example block diagram of a computer which can be implemented as a terminal device or network endpoint according to an embodiment of the present disclosure.

FIG. 14 is a block diagram illustrating a first example of a schematic configuration of a gNB to which the technology of the present disclosure can be applied.

FIG. 15 is a block diagram illustrating a second example of a schematic configuration of a gNB to which the technology of the present disclosure can be applied.

FIG. 16 is a block diagram illustrating an example of a schematic configuration of an smartphone to which the technology of the present disclosure can be applied.

FIG. 17 is a block diagram illustrating an example of a schematic configuration of a car navigation device to which the technology of the present disclosure can be applied.

FIG. 18A illustrates an example of layer-level computation and communication resource evaluation for an AlexNet model.

FIG. 18B illustrates an example of layer-level computation and communication resource evaluation for a VGG-16 model.

Although the embodiments described in the present disclosure can have various modifications and alternatives, specific embodiments thereof are illustrated as examples in the accompany drawings and described in detail in this specification. It should be understood that the drawings and detailed description thereof are not intended to limit embodiments to the specific forms disclosed, but to cover all modifications, equivalents, and alternatives falling within the spirit and scope of the claims.

### DESCRIPTION OF EMBODIMENTS

The following describes representative applications of various aspects of the device and method according to the present disclosure. The description of these examples is merely to add context and help to understand the described embodiments. Therefore, it is clear to those skilled in the art that the embodiments described below can be implemented without some or all of the specific details. In other instances, well-known process steps have not been described in detail to avoid unnecessarily obscuring the described embodiments. Other applications are also possible, and the solution of the present disclosure is not limited to these examples.

Generally, all terms used herein will be interpreted in accordance with their ordinary meaning in the related art, unless different meanings and/or implications are clearly given in the context. Unless otherwise expressly stated, references to elements, apparatuses, components, units, and operations are intended to be interpreted openly as at least one instance of the elements, the apparatuses, the components, the units, and the operations. Operations of any method disclosed herein need not be performed in the exact order disclosed unless the operations are explicitly or implicitly described after or before another operation. Any feature of any embodiment disclosed herein can be applied to any other suitable embodiment. Similarly, any advantage of any embodiment can be applied to any other embodiment, and vice versa. Other objects, features, and advantages of the embodiments will become apparent from the following descriptions.

### Example of a Communication System

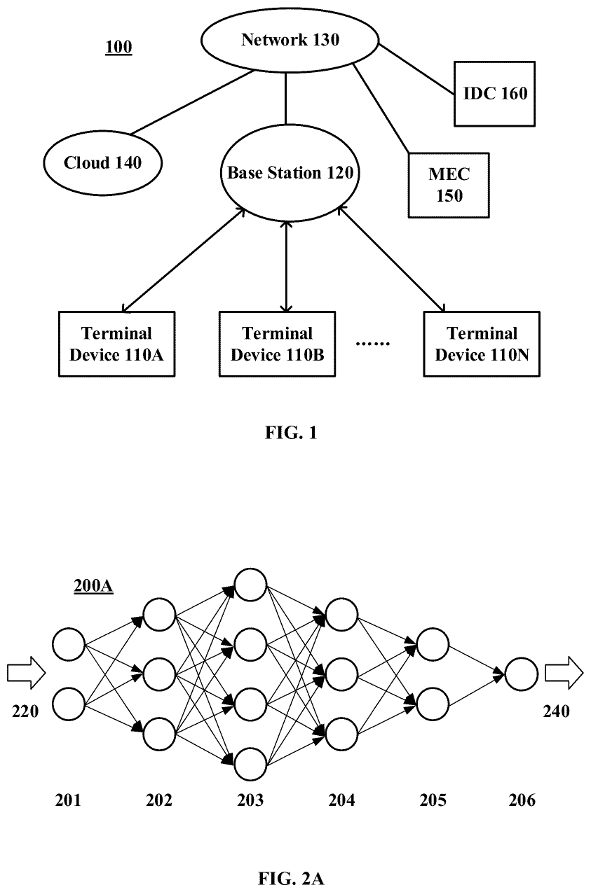

FIG. 1 illustrates an example block diagram of a communication system according to an embodiment of the present disclosure. It should be noted that FIG. 1 illustrates only one of multiple types and possible arrangements of wireless communication systems, and features of the present disclosure can be implemented in any one of the various systems as desired.

As shown in FIG. 1, the communication system 100 includes a base station 120, and terminal devices 110A, and 110B to 110N. The base station 120 and the terminal devices 110A to 110N can be configured to perform uplink and downlink communication through Uu interfaces. The terminal devices 110A to 110N can be configured to perform sidelink communication through PC5 interfaces. Accordingly, the base station 120 can allocate transmission resources to the uplink, the downlink, and the sidelink based on transmission requirements of a specific terminal device and resource conditions. In addition, the base station 120 can be configured to communicate with a network 130 (for example, a core network of a cellular service provider, or the Internet or a telecommunication network such as a public switched telephone network (PSTN)). Therefore, the base station 120 can facilitate communications between the terminals 110A to 110N and/or between the terminals 110A to 110N and the network 130, and the terminal devices 110A to 110N can perform direct communications within an effective communication range of the sidelink.

Based on service requirements, use cases, and/or available spectrums, the base station 120 can be configured to use various radio access technologies (RATs). In FIG. 1, a coverage area of the base station 120 can be referred to as a cell, and the base station 120 and other similar base stations (not shown) can provide continuous or approximately continuous communication signal coverage to the terminals 110A to 110N over a wide geographical area.

As shown in FIG. 1, the communication system 100 includes a cloud 140, a mobile edge computing (MEC) 150, and an internet data center (IDC) 160. The cloud 140 can provide services such as IaaS, PaaS, and SaaS for terminal devices over the network 130. In the cloud 140 and the MEC 150, computation resources (for example, servers) can be deployed to support computation requirements of communication services (for example, a communication and computation convergence service). Generally, the cloud 140 can be deployed on a remote server, and the MEC 150 can be located on a base station, a central office, or any aggregation point in the network. Therefore, compared with the cloud 140, the MEC 150 is closer to the terminal device, thereby helping reduce network congestion, reduce delay, and improve quality of experience (QoE) of users. The IDC 160 can provide hosting services so as to provide operation and maintenance based on the Internet for various devices (including computing devices) that collect, store, process, and transmit data in a centralized manner. In the present disclosure, the base station 120, devices in the cloud 140, the MEC 150, or the IDC 160, and any similar entities in the network can be referred to as network endpoints.

In the present disclosure, the base station can be a 5G NR base station or a 5G LTE-A base station, for example, a gNB and an ng-eNB. The gNB can provide an NR user plane and control plane protocol for terminating with the terminal device. The ng-eNB is a node defined for compatibility with a 4G LTE communication system and can be an upgrade of an evolved NodeB (eNB) of an LTE radio access network, providing an evolved universal terrestrial radio access (E-UTRA) user plane and control plane protocol for terminating with the UE. In addition, examples of base stations can include but are not limited to: at least one of a base transceiver station (BTS) and a base station controller (BSC) in a GSM system; at least one of a radio network controller (RNC) and a Node B in a WCDMA system; access points (APs) in WLAN and WiMAX systems; and corresponding network nodes in any communication system to be developed or being developed. In the present disclosure, some functions of the base station can alternatively be implemented as an entity that has a control function on communication in a scenario of D2D, M2M, and V2X, or as an entity that performs spectrum coordination in a cognitive radio communication scenario.

In the present disclosure, the terminal device can encompass its full range of common meanings. For example, the terminal device can be a mobile station (MS) or user equipment (UE). The terminal device can be implemented as a device such as a mobile phone, a handheld device, a media player, a computer, a laptop computer, a tablet computer, an on-board unit (OBU), a vehicle, a roadside unit (RSU), a wearable device, an Internet of things (IoT) device, or a wireless device of almost any type. In some cases, the terminal device can perform communication by using a plurality of wireless communications technologies. For example, the terminal device can be configured to communicate with one or more of GSM, UMTS, CDMA2000, WiMAX, LTE, LTE-A, WLAN, NR, Bluetooth, and the like.

### Split AI/ML Model and Model Inference

Artificial intelligence (AI) is the science and engineering of creating intelligent machines that are capable of performing tasks in a manner similar to humans. A sub-domain of AI is machine learning (ML), which enables computers to learn without explicit programming. Specifically, ML algorithms can be trained to learn how to handle new problems without the need to create a specialized program to solve each new problem. ML algorithms include, for example, decision tree, K-means clustering, and Bayesian network. For example, these algorithms can be used for classification and prediction after training models by using data samples. In the field of ML, neural networks (NN) are commonly used as models.

For a specific AI/ML task, multiple alternative AI/ML models can be established for model inference. For example, for image recognition tasks, alternative AI/ML models available for model inference include the AlexNet model, the VGG-16 model, the ResNet-152 model, the GoogleNet model, and the like. The sizes of these models range from dozens of megabytes to several hundred megabytes. In an implementation, the terminal device can download a specific model configuration of a specific model from the network in real time when required, or the terminal device can download the specific model configuration of the specific model from the network semi-statically through higher layer configuration. In an implementation, to reduce the amount of data for transmitting the model configuration, the specific model configuration of the configured specific model can be written into the terminal device (such as a chip). The specific model configuration of the specific model can include various model parameters such as a number of layers of the model, a number of neurons and weights per layer, and connection relationships for the neurons between layers.

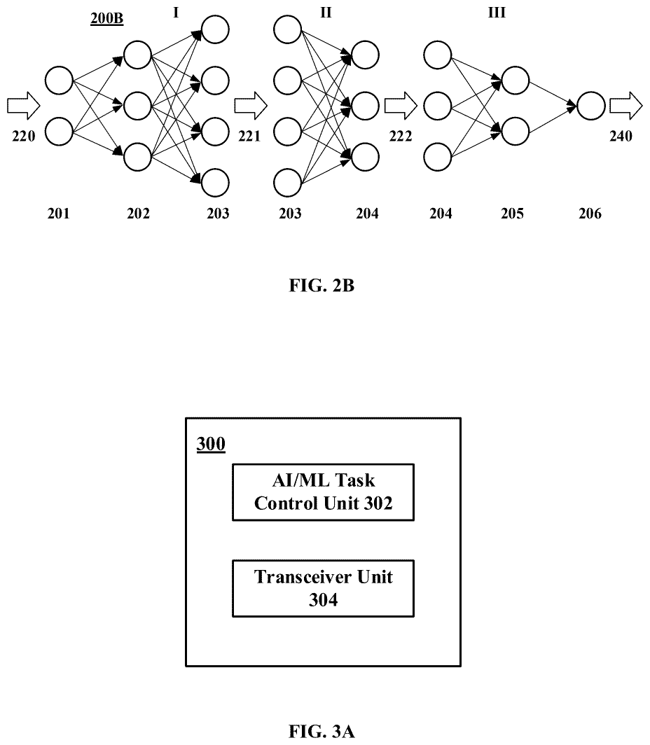

FIG. 2A illustrates an AI/ML model according to an embodiment of the present disclosure. As an example, the AI/ML model 200A in FIG. 2A is a neural network model. As shown in FIG. 2A, the AI/ML model 200A includes a plurality of layers, including an input layer 201, an output layer 206, and intermediate layers (or hidden layers) 202 to 205. Each layer has a specific number of neurons, each neuron has a specific weight, and there are connections between neurons of different layers. When input values 220 are input to the AI/ML model 200A, neurons at the input layer 201 first receive respective values and propagate the respective values to neurons of the intermediate layer 202 through connections with neurons of a next layer. Neurons of the intermediate layer 202 calculate a weighted sum of output values of the neurons of a previous layer and output the weighted sum to neurons of a next intermediate layer 203 through connections with neurons of a next layer. This proceeds until neurons of the output layer 206 calculate a weighted sum of output values of neurons of a previous layer and outputs an inference result 240 for the input values 220.

In the example of FIG. 2A, the AI/ML model 200A has four intermediate layers 202 to 205. Depending on application requirements, the number of intermediate layers can be arbitrary, which is not limited in the present disclosure. The AI/ML model 200A is composed of a series of fully connected layers (that is, all outputs are connected to all inputs) and is referred to as a multilayer perceptron (MLP) model. As a further example, the neural network model further includes a convolutional neural network (CNN) and a cyclic neural network (RNN) model. Although the MLP model is more referred to in the following description, the embodiments of the present disclosure can be applied to various other types of AI/ML models.

Generally, the more complex the AI/ML model is, the larger the computation amount and the storage volume is for performing model inference by using the AI/ML model. Taking the neural network model as an example, the neural network model with more layers and more connections between neurons indicates larger computation amount and storage volume for performing model inference by using the neural network model. Typically, computation resources used by a single terminal device (for example, 110A) to support model inference are limited. In an embodiment of the present disclosure, other terminal devices (for example, 110B, 110N) and/or a base station (for example, 120) can participate in the inference process of the AI/ML model to share resource consumption of a single terminal device (for example, 110A). For example, the AI/ML model can be split into multiple parts and model inference is performed by each participant device only on a respective part of the AI/ML model, instead of the entire AI/ML model.

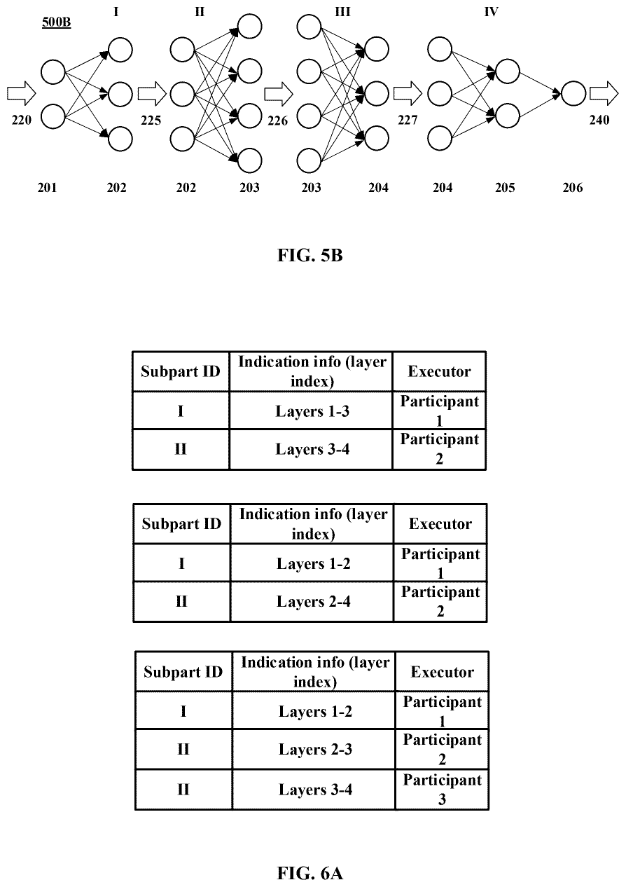

FIG. 2B illustrates a split AI/ML model according to an embodiment of the present disclosure. As an example, the split AI/ML model 200B is obtained by splitting the AI/ML model 200A. As shown in FIG. 2B, the AI/ML model 200A is split into three parts through two split points (that is, layers 203 and 204). Specifically, part I includes the input layer 201 and intermediate layers 202-203, part II includes intermediate layers 203-204, and part III includes intermediate layers 204-205 and the output layer 206. It should be understood that the split parts of the AI/ML model can be provided in any other appropriate quantities, and the AI/ML model can be split in multiple manners, as described in detail below with reference to FIG. 5A and FIG. 5B.

In an embodiment of the present disclosure, model inference performed by a plurality of participant devices on a split AI/ML model can be referred to as split model inference. For example, in a case that a specific AI/ML task of the terminal device 110A would otherwise require use of the AI/ML model 200A, the entire AI/ML model 200A can be split into the AI/ML model 200B based on state information of the terminal device 110A and other terminal devices, and the terminal device 110A and other participant devices (including terminal devices and/or the base station 120) jointly perform model inference on the AI/ML model 200B. Specifically, the terminal device 110A inputs input values corresponding to the AI/ML task into the part I and obtains intermediate data 221 through inference. Then, the terminal device 110A transmits the intermediate data 221 to a downstream participant device, such as the terminal device 110B. At the terminal device 110B, the intermediate data 221 is input into the part II and intermediate data 222 is obtained through inference. Then, the terminal device 110B transmits the intermediate data 222 to a downstream participant device, such as the base station 120. At the base station 120, the intermediate data 222 is input into the part III and result data 240 is obtained through inference. Then, the base station 120 can return the result data 240 to the terminal device 110A. It should be understood that participant devices performing model inference can be in any other appropriate quantities.

In the foregoing split model inference, the terminal device 110A directly related to the AI/ML task and model inference can be referred to as a primary participant device, and the terminal device 110B and the base station 120 that assist in model inference can be referred to as secondary participant devices. On the one hand, the primary participant device performs model inference on the first split part (that is, part I), so that input values corresponding to the AI/ML task and possibly involving privacy can be locally input into the AI/ML model on the primary participant device, thereby avoiding data leakage and improving security. On the other hand, each participant device needs to perform model inference only on part I, II or III, thereby reducing resource requirements of complex model inference for a single device.

In an embodiment of the present disclosure, for model inference performed by the terminal device 110A acting as the primary participant device, AI/ML model splitting (for example, splitting the AI/ML model 200A into the AI/ML model 200B) can be performed by the terminal device 110A, the base station 120, or any AI/ML-related network endpoint. In addition, the secondary participant devices can include other terminal devices and network endpoints (including the base station 120 or any device with computation power, such as devices in the cloud 140, the MEC 150, or the IDC 160). In some embodiments, the secondary participant devices include only other terminal devices. In some embodiments, the secondary participant devices include only network endpoints. In some embodiments, the secondary participant devices include both other terminal devices and network endpoints.

In a case that a network endpoint (for example, the base station 120) is required to participate in model inference, the AI/ML model can be pre-split into parts corresponding to the primary terminal device 110A and the base station 120. For example, the AI/ML model 200A can be pre-split into layers 201 to 204 corresponding to the terminal device 110A and layers 204 to 206 corresponding to the base station 120. In this case, in order to share the computation load of model inference performed by the terminal device 110A, the model splitting according to an embodiment of the present disclosure can include splitting at least a part of the AI/ML model into a plurality of subparts (for example, splitting the layers 201-204 into parts I and II), so that another terminal device can participate in the model inference on such part.

In some embodiments, the primary participant device can be a user equipment, and the secondary participant devices can include various vehicles. For example, the vehicle can have a wireless communication capability and an AI/ML model inference capability. Compared with the user equipment, the vehicle can have a stronger computation capability and more power storage, so it is suitable to assist another device in performing split model inference. In an embodiment, a degree to which the primary and secondary participant devices participate in model inference can be controlled based on nature of the vehicle. For example, the vehicle can be a public vehicle such as a taxi or a bus. Accordingly, the user equipment needs to perform model inference on a larger model part (for example, part I in FIG. 2B can be larger), so as to avoid leaking privacy data to a public vehicle. For another example, the vehicle can be a vehicle of a friend or a private vehicle. Accordingly, in a case that a privacy requirement is satisfied to some extent, the user equipment can perform model inference on an appropriately smaller part of the model (for example, part I in FIG. 2B can be smaller), thereby giving full play to the role of the vehicle in assisting model inference to a greater extent. In some cases, the user can even provide local data directly to the vehicle and instruct the vehicle to perform model inference, with no need to perform model inference by itself.

It should be understood that the split model inference requires transmission of model inference information, such as intermediate data and result data, between a plurality of participant devices. Further, a delay of transmitting the model inference information should be reasonable to ensure that the entire model inference process is completed within a specified period of time. In an embodiment of the present disclosure, the base station 120 can allocate resources to the plurality of participant devices, for transmitting model inference information between the plurality of participant devices, thereby facilitating execution of split model inference.

### Examples of Electronic Devices

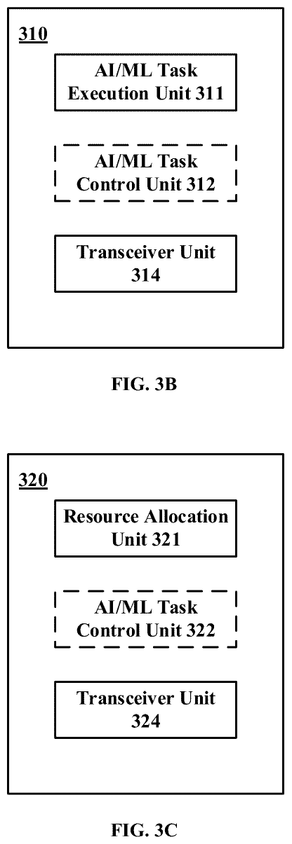

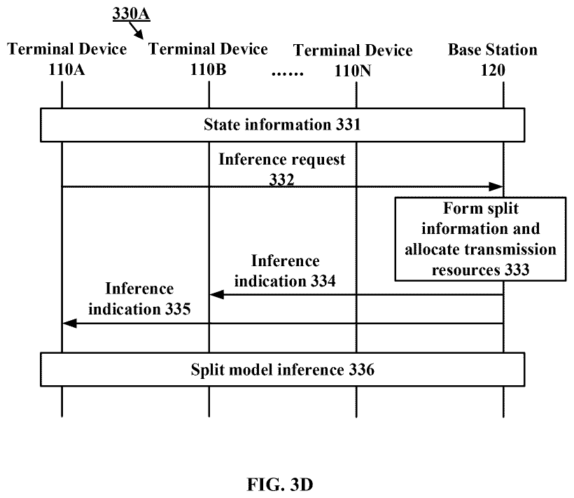

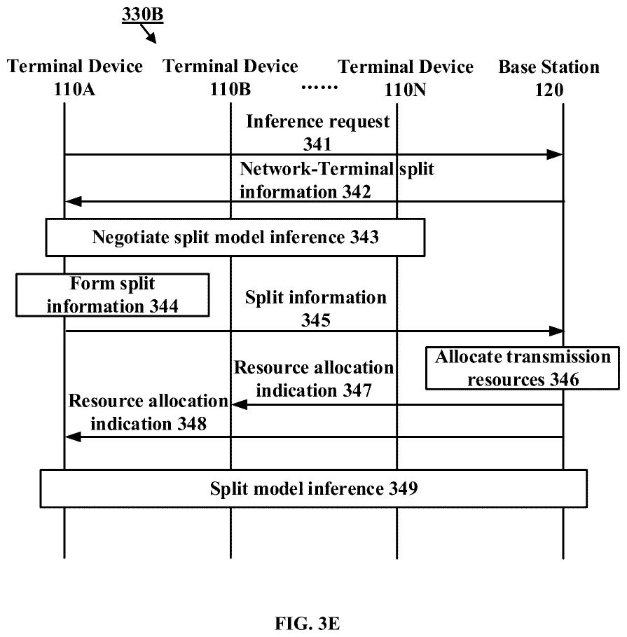

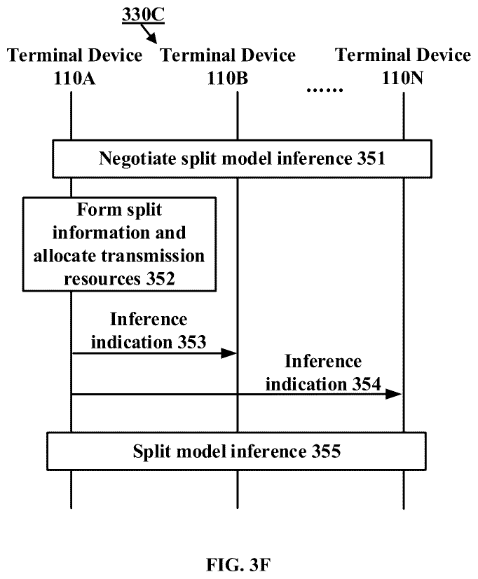

FIG. 3A illustrates an example electronic device 300 for a terminal device or a network endpoint according to an embodiment of the present disclosure. The terminal device can correspond to a primary participant device (for example, the terminal device 110A), and the network endpoint includes, for example, a base station 120, or a device in the cloud 140, the MEC 150, or the IDC 160.

The electronic device 300 can include various units to implement embodiments of AI/ML model splitting and model inference according to the present disclosure. In the example of FIG. 3A, the electronic device 300 includes an AI/ML task control unit 302 and a transceiver unit 304. For example, the AI/ML task control unit 302 can be configured to split an AI/ML model (for example, the AI/ML model 200), and the transceiver unit 304 can be configured to perform communication with other devices. The following operations described with reference to a terminal device or the network endpoint and with reference to the AI/ML model splitting can be implemented by the units 302 to 304 or other possible units of the electronic device 300.

In an embodiment, the AI/ML task control unit 302 can form split information of at least a first part of the AI/ML model 200A based on respective state information of the terminal device 110A and one or more other terminal devices. For example, the split information can specify that split model inference is to be performed by a plurality of participant devices on a plurality of subparts of at least the first part of the AI/ML model 200A. In some examples, at least the first part of the AI/ML model 200A can correspond to part or all of the AI/ML model 200A. Accordingly, the entire AI/ML model 200A can be split into subparts I, II, and III; or in a case that the part III is pre-split, only the layers 201 to 204 of the AI/ML model 200A can be split into subparts I and II. In an example, the AI/ML model 200A is a model corresponding to a specific AI/ML task. For example, the AI/ML task can be image recognition, and the AI/ML model 200A is a model trained to recognize content in images.

In an embodiment, the AI/ML task control unit 302 can cause, based on the split information, a wireless network to allocate to at least one of the plurality of participant devices resources for transmitting model inference information. The allocated resources can be used for a sidelink and/or an uplink and a downlink.

In an embodiment, the transceiver unit 304 can receive state information of a plurality of terminal devices to split the AI/ML model 200A. The transceiver unit 304 can further transmit a resource allocation request to a network (for example, the base station 120 or a resource allocation unit thereof), so as to cause the wireless network to allocate to at least one of the plurality of participant devices resources for transmitting model inference information. The transceiver unit 304 can be further configured to control or perform an operation related to signaling or message transceiving.

In an embodiment, the electronic device 300 can be implemented at a chip level or can be implemented at a device level by including other external components (for example, wired or wireless links). The electronic device 300 can operate as a whole unit and act as a communication device.

FIG. 3B illustrates an example electronic device 310 for a terminal device according to an embodiment of the present disclosure. The terminal device can correspond to a primary or secondary participant device.

The electronic device 310 can include various units to implement embodiments of AI/ML model inference according to the present disclosure. In the example of FIG. 3B, the electronic device 310 includes an AI/ML task execution unit 311 and a transceiver unit 314. For example, the AI/ML task execution unit 311 can be configured to perform model inference on subparts (for example, parts I or II) of the AI/ML model (for example, the AI/ML model 200B). The transceiver unit 314 can be configured to perform communication with a base station or another device, such as transmitting model inference information. The following operations described with reference to a terminal device and AI/ML model inference can be implemented by the units 311 and 314 or other possible units of the electronic device 310.

In an embodiment, the AI/ML task execution unit 311 is configured to perform model inference on a subpart I of the split AI/ML model 200B. For example, the AI/ML task execution unit 311 can input an input value corresponding to a specific application into the subpart I to obtain intermediate data 221. Accordingly, the transceiver unit 314 can be configured to provide the intermediate data 221 to a downstream participant device (for example, via a sidelink).

In an embodiment, the AI/ML task execution unit 311 is configured to perform model inference on a subpart II of the split AI/ML model 200B. For example, the transceiver unit 314 can be configured to receive intermediate data from an upstream participant device, and the AI/ML task execution unit 311 can input the intermediate data into the subpart II to obtain intermediate data 222. Accordingly, the transceiver unit 314 can be configured to provide the intermediate data 222 to a downstream participant device (for example, via a sidelink).

In an embodiment, the AI/ML task execution unit 311 is configured to perform model inference on a subpart III of the split AI/ML model 200B. For example, the transceiver unit 314 can be configured to receive intermediate data from an upstream participant device, and the AI/ML task execution unit 311 can input the intermediate data into the subpart III to obtain result data 240. Accordingly, the transceiver unit 314 can be configured to provide the result data 240 to the primary participant device (for example, via a sidelink).

Optionally, the electronic device 310 can further include an AI/ML task control unit 312. The AI/ML task control unit 312 can be configured to split the AI/ML model (for example, the AI/ML model 200A). An operation of the AI/ML task control unit 312 is similar to that of the AI/ML task control unit 302, thus can be further understood with reference to descriptions on the electronic device 300.

In an embodiment, the electronic device 310 can be implemented at a chip level or can be implemented at a device level by including other external components (for example, a radio link and an antenna). The electronic device 310 can operate as a whole unit and act as a communication device.

FIG. 3C illustrates an example electronic device 320 for a base station according to an embodiment of the present disclosure. The base station can correspond to the base station 120.

The electronic device 320 can include various units to implement embodiments of allocating transmission resources to facilitate AI/ML model inference according to the present disclosure. In the example of FIG. 3C, the electronic device 320 includes a resource allocation unit 321 and a transceiver unit 324. For example, the resource allocation unit 321 can be configured to allocate resources to at least one of the plurality of participant devices for transmitting model inference information. The transceiver unit 304 is configured to perform communication with another network endpoint and/or terminal device. The following operations described with reference to a base station and resource allocation can be implemented by the units 321 and 324 or other possible units of the electronic device 320.

In an embodiment, the resource allocation unit 321 can obtain split information of at least a first part of an AI/ML model. For example, the transceiver unit 324 can receive the split information of at least the first part of the AI/ML model from a terminal device or a network endpoint. The AI/ML model corresponds to an AI/ML task of a primary participant device, and the split information specifies that split model inference is to be performed by a plurality of participant devices on a plurality of subparts of at least the first part of the AI/ML model. The resource allocation unit 321 can allocate, based on the split information, to at least one of the plurality of participant devices, resources for transmitting the model inference information.

Optionally, the electronic device 320 can further include an AI/ML task control unit 322. The AI/ML task control unit 322 can be configured to split the AI/ML model (for example, the AI/ML model 200A). Operations of the AI/ML task control unit 312 is similar to that of the AI/ML task control unit 302, thus can be further understood with reference to descriptions on the electronic device 300.

In an embodiment, the electronic device 320 can be implemented at a chip level or can be implemented at a device level by including other external components (for example, a radio link and an antenna). The electronic device 320 can operate as a whole unit and act as a communications device.

It should be noted that the foregoing units are merely logical modules classified based on specific functions implemented by the units and are not intended to limit specific implementations, for example, the units can be implemented in a manner of software, hardware, or a combination of software and hardware. In actual implementation, the foregoing units can be implemented as independent physical entities or can be implemented by a single entity (for example, a processor (CPU or DSP) or an integrated circuit). The processing circuit can refer to various implementations of a digital circuit system, an analog circuit system, or a hybrid signal (a combination of analog and digital) circuit system that performs functions in a computing system. The processing circuit can include, for example, a circuit such as an integrated circuit (IC), an application specific integrated circuit (ASIC), a part or circuit of a separate processor core, an entire processor core, a separate processor, a programmable hardware device such as a field programmable gate array (FPGA), and/or a system including multiple processors.

### Examples of Overall Procedures

FIG. 3D to FIG. 3F illustrate exemplary procedures for split model inference according to an embodiment of the present disclosure. The following describes procedures 330A and 330C with reference to the terminal devices 110A to 110N and the base station 120, where the terminal device 110A is a primary participant device for model inference, and other devices can serve as secondary participant devices in different scenarios.

As shown in FIG. 3D, at 331, each terminal device reports state information (for indicating a computation state and/or a communication state, for example) of the terminal device to the base station 120. In an embodiment, reporting can be periodic or event-based (for example, in response to a request from the base station 120). At 332, as a primary participant of a specific AI/ML task, the terminal device 110A transmits a model inference request to the base station 120. For example, the request can include AI/ML task indication information or corresponding AI/ML model indication information. At 333, upon receiving the model inference request, the base station 120 forms split information for split model inference and allocates transmission resources to assist execution of the model inference. For example, forming the split information can include determining, by the base station 120, a model split point between the base station and the terminal device side, and determining a model split point between the terminal devices 110A and 110B that participate in inference. In an example, the model split point between the base station and the terminal device side can be pre-configured for a specific AI/ML model. Forming the split information can further include forming, based on the split points, a service flow for performing the model inference by the participant devices. In an example, the service flow can be the terminal device 110A->the terminal device 110B->the base station 120->the terminal device 110A. Further, the base station 120 can allocate sidelink resources between the terminal devices 110A and 110B based on the split information, to transmit intermediate data between the two terminal devices, and allocate uplink resources between the terminal device 110B and the base station 120 and downlink resources between the base station 120 and the terminal device 110A to transmit intermediate data and result data between the terminal devices and the base station 120. At 334 and 335, the base station 120 transmits inference indication messages respectively to the terminal devices 110A and 110B participating in model inference. The inference indication message can indicate a split part and transmission resource allocation corresponding to respective terminal device. At 336, multiple participant devices perform split model inference together based on respective split parts and transmission resource allocations. After the model inference is completed, the allocated transmission resources can be released.

In the procedure 330A, the base station 120 is responsible for splitting the AI/ML model and forming the split information, and the base station 120 allocates transmission resources to the participant devices to assist execution of the split model inference. In some embodiments, another network endpoint (such as a device in the cloud 140, the MEC 150, or the IDC 160) can be responsible for splitting the AI/ML model and forming the split information, and transmission resources are allocated to the participant devices still by the base station 120. In such an embodiment, the base station 120 needs to forward received state information of each terminal device and an inference request of the terminal device 110A to the network endpoint. Similar to the base station 120, the network endpoint can form split information and forward the split information to the base station 120, so that the base station 120 allocates transmission resources similarly. It should be understood that subsequent operations can be similar to those in the procedure 330A.

In the following procedure 330B, the split information is formed by the terminal device 110A acting as a primary participant device of a specific AI/ML task, and the base station 120 allocates transmission resources to the participant devices to assist execution of the split model inference. As shown in FIG. 3E, at 341, the terminal device 110A transmits a model inference request to the base station 120. For example, the request can include AI/ML task indication information or corresponding AI/ML model indication information. At 342, upon receiving the model inference request, the base station 120 can determine a model split point between the base station 120 and the terminal device side based on the AI/ML task indication information or the corresponding AI/ML model indication information, and transmit the model split point to the terminal device 110A. In an example, the split point can be pre-configured for a specific AI/ML model. Once the model split point between the base station 120 and the terminal device side is determined, at 343, the terminal device 110A can negotiate with another terminal device to participate in the split model inference. For example, the terminal device 110A can similarly transmit a model inference request to other terminal devices. When being able to participate in split model inference is determined based on the AI/ML task indication information or the corresponding AI/ML model indication information, the terminal device 110B, 110N, and the like can report respective state information to the terminal device 110A. Then, for example, the terminal device 110A can determine, based on the state information, the terminal device 110B as a participant device, and form split information for the model inference. For example, forming the split information can include determining a model split point between the terminal devices 110A and 110B that participate in the inference. Forming the split information can further include forming, based on the split points, a service flow for performing the model inference by the participant devices. In an example, the service flow can be the terminal device 110A->the terminal device 110B->the base station 120->the terminal device 110B->the terminal device 110A. At 345, the terminal device 110A transmits split information of the terminal device side to the base station 120. At 346, upon receiving the split information, the base station 120 allocates transmission resources, so as to assist execution of the split model inference. For example, the base station 120 can allocate sidelink resourced for the terminal devices 110A and 110B based on the split information, so as to transmit intermediate data and result data between the two terminal devices, and can allocate uplink and downlink resources for the terminal device 110B and the base station 120, so as to transmit intermediate data and result data between the terminal device and the base station 120. At 347 and 348, the base station 120 transmits inference indication messages respectively to the terminal devices 110A and 110B participating in the model inference. The inference indication message can indicate split parts and transmission resource allocation corresponding to each terminal device. At 349, multiple participant devices perform the split model inference together based on respective split parts and transmission resource allocations. After the model inference is completed, the allocated transmission resources can be released.

In the following procedure 330C, only the terminal devices participate in the model inference, and the terminal device 110A acting as a primary participant device of a specific AI/ML task is responsible for forming split information and allocating transmission resources to other terminal devices. As shown in FIG. 3F, at 351, the terminal device 110A can negotiate with other terminal devices to participate in split model inference. For example, the terminal device 110A can similarly transmit a model inference request to another terminal device. When being able to participate in split model inference is determined based on the AI/ML task indication information or the corresponding AI/ML model indication information, the terminal device 110B, 110N, and the like can report respective state information to the terminal device 110A. At 352, for example, the terminal device 110A can determine, based on the state information, the terminal devices 110B and 110N acting as participant devices, and form split information for the model inference. For example, forming the split information can include determining model split points between the terminal devices that participate in the inference. Forming the split information can further include forming, based on the split points, a service flow for performing the model inference by the participant devices. In an example, the service flow can be the terminal device 110A->the terminal device 110B->the terminal device 110N->the terminal device 110B->terminal device 110A, or the terminal device 110A->the terminal device 110B->the terminal device 110N->the terminal device 110A. The terminal device 110A further allocates transmission resources in an autonomous manner to facilitate execution of the split model inference. For example, the terminal device 110A can allocate sidelink resources between the terminal devices based on the split information, so as to transmit intermediate data and/or result data between two terminal devices. At 353 and 354, the terminal device 110A transmits inference indication messages respectively to the terminal devices 110B and 110N participating in model inference. The inference indication message can indicate split parts and transmission resource allocations corresponding to respective terminal devices. At 355, multiple participant devices perform the split model inference based on respective split parts and transmission resource allocations. After the model inference is completed, the allocated sidelink resources can be released.

### Examples of AI/ML Model Splitting

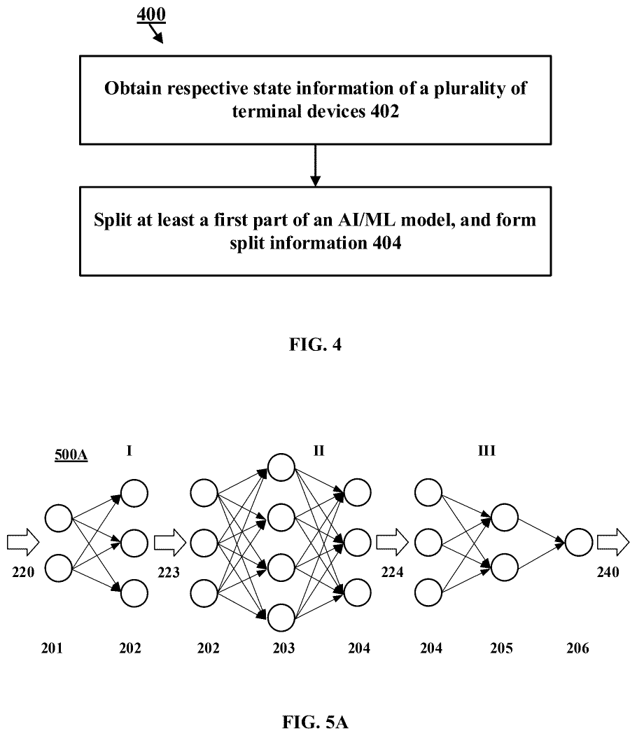

FIG. 4 illustrates an exemplary operation for splitting an AI/ML model according to an embodiment of the present disclosure. For example, the example operation 400 can be performed by a primary participant device (for example, the terminal device 110A), a base station (for example, 120), or another network endpoint (for example, a device in the cloud 140, the MEC 150, or the IDC 160).

As shown in FIG. 4, the example operation 400 includes obtaining respective state information of a plurality of terminal devices (402). The plurality of terminal devices include a primary participant device (i.e., the terminal device 110A) and one or more other terminal devices. For example, each terminal device can periodically transmit (for example, broadcast) state information of the terminal device, so that a device that performs model splitting can receive the state information. It should be noted that the state information can indicate a state associated with the model inference. For example, the state information can indicate a computation state of a respective terminal device, for example, including at least one of a computation resource (such as a CPU, a GPU) usage state, a storage resource (such as a RAM) usage state, or a power level. Additionally or alternatively, the state information can indicate a communication state of a respective terminal device, for example, including channel state information that reflects at least one of channel quality, a number of transport layers, or a data rate of an uplink, a downlink, or a sidelink. The terminal device can perform channel estimation by receiving pilot information or reference information from a base station or another terminal device.

In an embodiment, the state information of the other one or more terminal devices can be obtained by the primary participant device (for example, the terminal device 110A). For example, the terminal device 110A can obtain capability information of other terminal devices, and the capability information indicates whether a respective terminal device supports participating in the split model inference. Then, the terminal device 110A can receive respective state information only from terminal devices supporting participation (including, for example, the terminal device 110B). In this way, power consumption corresponding to listening on state information broadcast can be reduced for the terminal device 110A.

As an example, in a case that other terminal devices are needed to participate in the split model inference, the terminal device 110A can learn, through a sidelink UE capability transfer process, whether other terminal devices support participation in the split model inference. Taking the sidelink UE capability transfer process with the terminal device 110B as an example, the terminal device 110A can transmit a UECapabilityEnquirySidelink message to the terminal device 110B, so as to query a capability of the terminal device 110B. In response to receiving a response of the UECapabilityEnquirySidelink message, the terminal device 110B can reply to the terminal device 110A with a UECapabilityInformationSidelink message, which includes capability information indicating whether the terminal device 110B supports participation in the split model inference. Additionally, the UECapabilityInformationSidelink message can include a model type supported by the terminal device 110B, for example, the AlexNet model, the VGG-16 model for image recognition. Additionally or alternatively, the UECapabilityInformationSidelink message can include a real-time computation state reflecting a current running status and/or an overall computation capability reflecting a configuration status of the terminal device 110B, so that the terminal device 110A can determine, based on the configuration status of the terminal device 110B and/or more accurately based on the current running status of the terminal device 110B, a specific manner in which the terminal device 110B participates in the split model inference.

The example operation 400 includes splitting at least a first part of an AI/ML model, and forming split information for at least the first part of the AI/ML model (404). Taking the AI/ML model 200A as an example, at least the first part can include layers 201 to 203, layers 201 to 204, or layers 201 to 206. For example, the splitting operation 404 is performed in response to determining that the computation state of the terminal device 110A is not sufficient to support inference on at least the first part of the AI/ML model 200A. Certainly, in a case that the computation state of the terminal device 110A indicates that a corresponding resource is sufficient, the splitting operation 404 can also be performed, so that the terminal device 110A can have remaining computation resources for other tasks or operations.

In an embodiment, the splitting operation 404 can include determining a terminal device with a computation state and/or a communication state being better than a specific threshold from one or more terminal devices. It should be noted that the computation state being better than the threshold can indicate that the respective terminal device has a computation resource, a storage resource, and/or a power level required for execution of the model inference. In an example, the primary participant device (that is, the terminal device 110A) and part or all of terminal devices determined based on the threshold are determined as participant devices.

In an embodiment, once the participant devices are determined, at least the first part of the AI/ML model 200A can be split into a plurality of subparts based on the participant devices and respective state information. For example, it can be determined how many subparts to be split based on the number of participant devices. Taking splitting the layers 201 to 204 of the AI/ML model 200A as an example, based on that the participant devices include the terminal devices 110A and 110B, it can be determined that the layers 201 to 204 need to be split into two subparts. For another example, split points for forming the plurality of subparts can be set based on the computation states of the participant devices, so that the inference workload on a subpart is compatible with the computation state of a participant device. This can facilitate a participant device to undertake a model inference workload that matches its own computation resource, storage resource, and/or power level. It should be understood that it is needed to determine a range of a split part for the primary participant device properly, so as to ensure that data corresponding to an AI/ML task and possibly involving privacy can be retained locally on the primary participant device, so as to avoid data leakage to a downstream participant device. FIG. 5A illustrates another example of a split AI/ML model according to an embodiment of the present disclosure. Both the AI/ML model 200B in FIG. 2B and the AI/ML model 500A in FIG. 5A are obtained, for example, by splitting the layers 201 to 204 of the AI/ML model 200A (for example, model inference on part III needs to be performed by the base station 120). In the AI/ML model 200B, the split point is at the layer 203. This requires the terminal device 110A to perform model inference on the layers 201 to 203, and the terminal device 110B merely performs model inference on the layers 203 to 204. In the AI/ML model 500A, the split point is at the layer 202. Accordingly, the terminal device 110A merely performs model inference on the layers 201 to 202, and the terminal device 110B needs to perform model inference on the layers 202 to 204. The splitting manner of the layers 201 to 204 can be determined based on computation states of the terminal devices 110A and 110B.

FIG. 5B illustrates still another example of a split AI/ML model according to an embodiment of the present disclosure. In this example, the split AI/ML model 500B includes four parts I to IV. In this example, model inference on part IV needs to be performed by the base station 120. In an embodiment, the terminal devices 110A, 110B, and 110N are determined as participant devices by performing the splitting operation 404. Accordingly, the layers 201 to 204 form three subparts I to III through two split points (i.e., the layers 202 and 203).

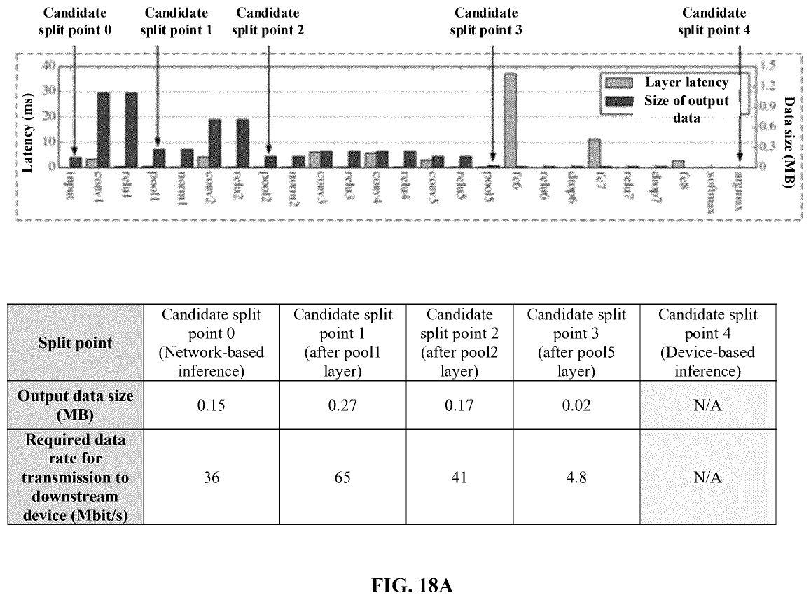

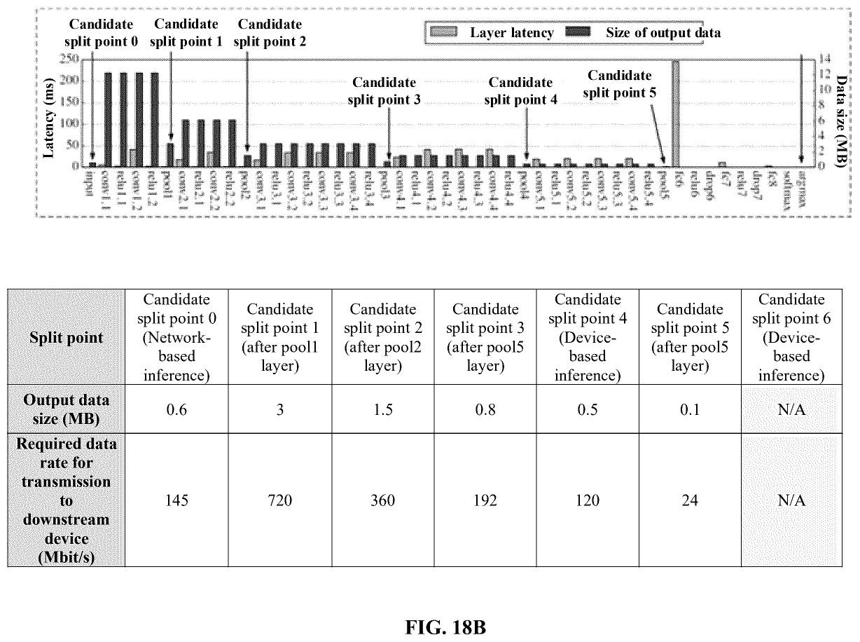

FIG. 18A illustrates an example of layer-level computation and communication resource evaluation for an AlexNet model. The AlexNet model is a CNN model used for image recognition. As shown in FIG. 18A, the architecture of the AlexNet model includes an input layer (denoted by “input”), a convolution layer (denoted by “conv”), a relu layer (denoted by “relu”), a cross-channel normalization layer (denoted by “norm”), a pooling layer (denoted by “pool”), a full connection layer (denoted by “fc”), a dropout layer (denoted by “drop”), a softmax layer (denoted by “softmax”), and an argmax layer (denoted by “argmax”). FIG. 18B illustrates an example of layer-level computation and communication resource evaluation for a VGG-16 model. The VGG-16 model is another CNN model for image recognition. As shown in FIG. 18B, the architecture of the VGG-16 model is similar to that of the AlexNet model.

The split AlexNet model or VGG-16 model can be analyzed based on computation and data characteristics of the layers in the model. As shown in FIGS. 18A and 18B, the size of intermediate data transmitted from a layer to a next layer depends on a position of a split point. Therefore, for a specific frame rate of an image, a data rate required for transmitting intermediate data to a downstream participant device by a participant device is related to a split point of the model. For example, assuming images (with a resolution of 227×227) in a video stream of 30 frames per second needs to be classified, for the AlexNet model, data rates corresponding to different split points range from 4.8 Mbit/s to 65 Mbit/s, and for the VGG-16 model, data rates corresponding to different split points range from 24 Mbit/s to 720 Mbit/s.

Taking the AlexNet model as an example, in an embodiment, a communication state threshold of 4.8 Mbit/s can be set for a data rate. Based on a specific scenario of the split model inference, the data rate can be for at least one of an uplink or a sidelink. Accordingly, a plurality of terminal devices whose data rates are higher than 4.8 Mbit/s can be determined by performing the splitting operation 404. The primary participant device (that is, the terminal device 110A) and part or all of the plurality of terminal devices can be determined as participant devices.

Once the participant devices are determined, split points for a plurality of subparts can be determined based on sidelink and uplink data rates of the participant devices, so that data rates required for transmission to downstream devices, corresponding to the split points, are compatible with the data rates of the participant devices. For example, the terminal device 110B having a maximum sidelink data rate (for example, 42 Mbits) with the terminal device 110A can be determined as a downstream participant device of the terminal device 110A, and a candidate split point 2 is determined as a split point. The terminal device 110N whose uplink data rate is greater than 4.8 Mbit/s can be determined as a downstream participant device of the terminal device 110B, and a candidate split point 3 is determined as a split point. This can facilitate transmitting intermediate data between a plurality of participant devices with a relatively small delay, so as to complete the entire model inference process over a period of time acceptable to the user.

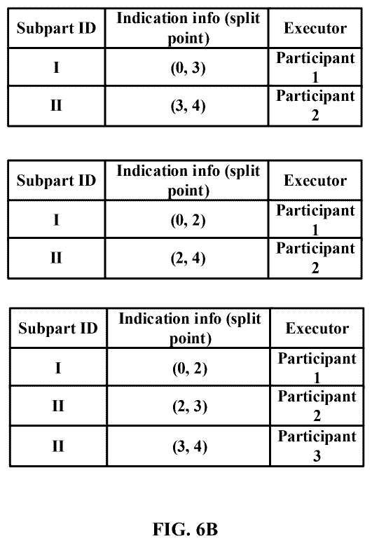

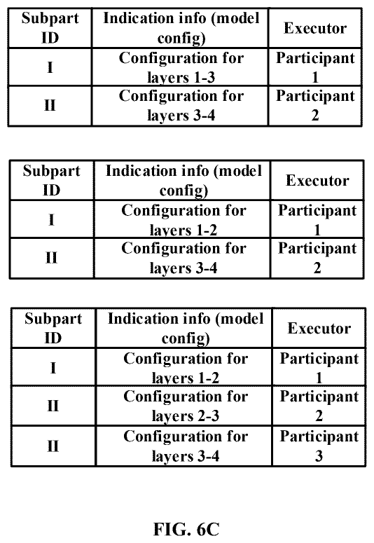

In some embodiments, the split information of the AI/ML model can include (1) indication information of the plurality of split subparts, and (2) information about participant devices that perform model inference. FIG. 6A illustrates a first example of split information according to an embodiment of the present disclosure. In FIG. 6A, split information respectively corresponding to the split AI/ML models 200B, 500A, and 500B is sequentially shown. In this example, the indication information is denoted by a specific layer index of a split subpart. Taking the split information of the AI/ML model 200B as an example, the “indication information” column indicates that the subpart I includes layers 1 to 3 of the complete AI/ML model 200A, and the subpart II includes layers 3 to 4. The “executor” column indicates that model inference on the subpart I is executed by a participant 1 and model inference on the subpart II is executed by a participant 2.

FIG. 6B illustrates a second example of split information according to an embodiment of the present disclosure. In FIG. 6B, split information respectively corresponding to the split AI/ML models 200B, 500A, and 500B is sequentially shown. In this example, the indication information is denoted by a split point of a formed subpart. Taking the split information of the AI/ML model 200B as an example again, the “indication information” column indicates that the subpart I is formed by a single split point at the third layer (that is, the subpart I is the first subpart) of the complete AI/ML model 200A, and the subpart II is formed by two split points at the third layer and the fourth layer. The “executor” column indicates that model inference on the subpart I is executed by a participant 1 and model inference on the subpart II is executed by a participant 2.

FIG. 6C illustrates a third example of split information according to an embodiment of the present disclosure. In FIG. 6C, split information respectively corresponding to the split AI/ML models 200B, 500A, and 500B is sequentially shown again. In this example, the indication information is denoted by a model configuration of the subpart. Taking the split information of the AI/ML model 200B as an example again, the “indication information” column includes specific model configurations of the subpart I and the subpart II, and includes the number of and weights of neurons per layer and connection relationships between the neurons of the layers. Similarly, the “executor” column indicates that model inference on the subpart I is executed by the participant 1 and model inference on the subpart II is executed by the participant 2.

It should be understood that, in some embodiments, an index (for example, a layer index or a split point) of a model part for model inference can be notified to the participant device through indication information of subparts (for example, as shown in FIG. 6A and FIG. 6B), so that the participant device determines a model configuration of the model part based on the index of the model part and the overall model configuration (for example, the complete model 200A). Because it usually needs to perform the same or similar AI/ML tasks, each participant device can locally have a same model configuration of the AI/ML model (for example, the model 200A), and model configurations of a plurality of participant devices can be updated synchronously. As described above, the local AI/ML model can be written to the participant device or semi-statically configured for the participant device. In this way, the participant device can determine a specific model configuration of a corresponding subpart based on an index of the subpart and the overall model configuration. Alternatively, in some embodiments, a specific model configuration of a model part for model inference can be notified to the participant device based on the indication information of the subparts (for example, as shown in FIG. 6C). Once a specific model configuration of a corresponding subpart is determined, the participant device can input an input value or intermediate data into the model part to obtain corresponding output data.

It should be understood that, based on participant device information (for example, the “executor” column), the split information specifies an order in which model inference is performed on respective subparts by the participant devices one by one, thus can represent a service flow for model inference. For example, three pieces of split information in FIG. 6A represent the service flow of “Participant 1->Participant 2”, “Participant 1->Participant 2”, and “Participant 1->Participant 2->Participant 3”, respectively. In some embodiments, information about at least a downstream participant device can be notified to a specific participant device based on the participant device information, so that the participant device knows how to transmit intermediate data generated by the participant device itself.

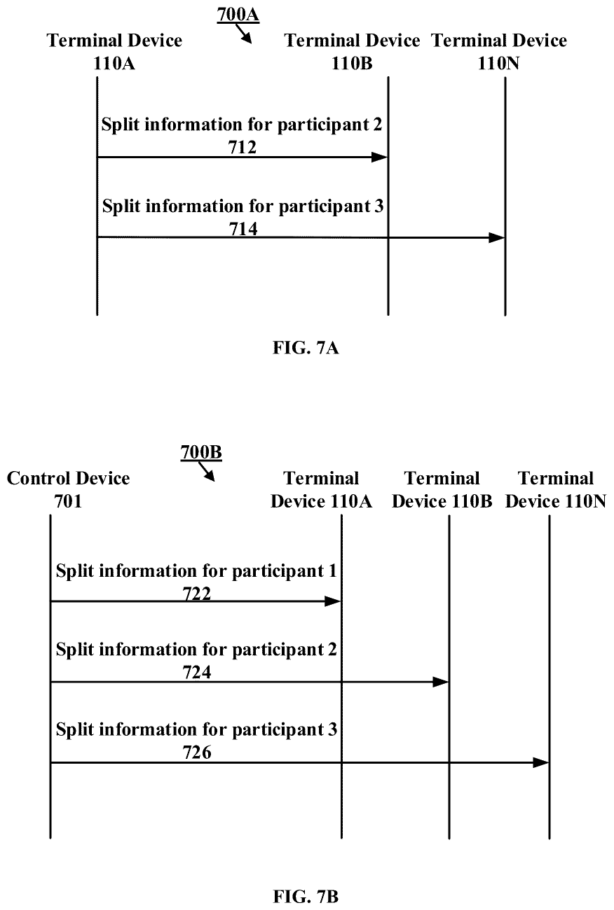

FIG. 7A illustrates a first example operation for distributing split information according to an embodiment of the present disclosure. The following describes an example operation 700A with reference to the AI/ML model 500B. In FIG. 7A, the terminal device 110A corresponds to the participant 1 and acts as a primary participant device, and the terminal devices 110B and 110N respectively correspond to the participants 2 and 3 and act as secondary participant devices. In this example, split information (for example, as shown in FIG. 6A and FIG. 6B) is formed and distributed by the primary participant device.

As shown in FIG. 7A, the example operation 700A includes that the terminal device 110A notifies a corresponding participant of the split information of the AI/ML model based on information in the “executor” column in the split information. Specifically, at 712, the terminal device 110A notifies the terminal device 110B acting as the participant 2 of the split information for the participant 2. At 714, the terminal device 110A notifies the terminal device 110N acting as the participant 3 of the split information for the participant 3.

In some embodiments, after forming the split information (for example, as shown in FIG. 6A and FIG. 6B), the primary participant device can provide the split information to the base station 120. In this way, the base station 120 can distribute the split information to a corresponding participant device by performing an operation similar to the 700A.

FIG. 7B illustrates a second example operation for distributing split information according to an embodiment of the present disclosure. The example operation 700B is still described by referring to the split AI/ML model 500B, where the terminal device 110A is a primary participant device, and the terminal devices 110B and 110N are secondary participant devices. In this example, split information (for example, as shown in FIG. 6A and FIG. 6B) is distributed by a control device 701, where the split information can be formed by the control device 701 or received from another device. The control device 701 can be the base station 120 or another network endpoint.

As shown in FIG. 7B, the example operation 700B includes that the control device 701 notifies a corresponding participant device of a subpart of the AI/ML model based on executor information in the split information. Specifically, at 722, the control device notifies the terminal device 110A acting as the participant 1 of the split information for the participant 1. At 724, the control device notifies the terminal device 110B acting as the participant 2 of the split information for the participant 2. At 726, the control device notifies the terminal device 110N acting as the participant 3 of the split information for the participant 3.

In the operations 700A and 700B, split information for a specific participant can include indication information of a corresponding subpart, so that the participant can determine a specific model configuration of the subpart. In an embodiment, the indication information can indicate at least index information of a corresponding subpart. Taking the operation 700A as an example, at 712, the terminal device 110A can notify the terminal device 110B acting as the participant 2 of index information of a subpart II; at 714, the terminal device 110A notifies the terminal device 110N acting as the participant 3 of index information of a subpart III. In this way, the terminal devices 110B and 110N can determine a specific model configuration of a corresponding subpart based on an overall model configuration (that is, 200A) and index information.

In an embodiment, the indication information can indicate a specific model configuration of a corresponding subpart. Taking the operation 700 as an example again, at 712, the terminal device 110A can notify the terminal device 110B acting as the participant 2 of a specific model configuration of the subpart II; at 714, the terminal device 110A notifies the terminal device 110N acting as the participant 3 of a specific model configuration of the subpart III.

### Examples of Split Model Inference

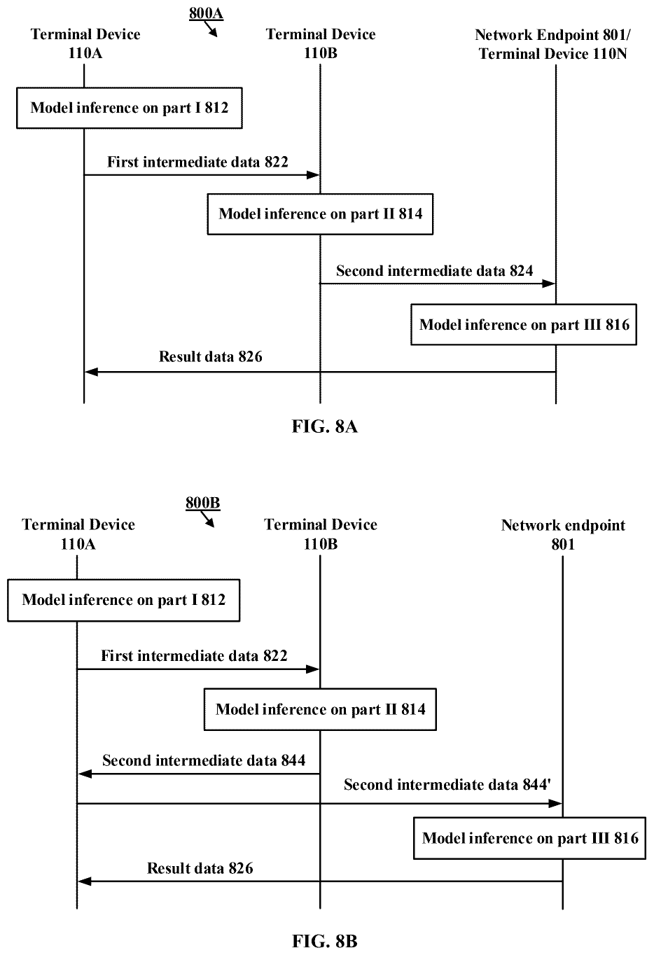

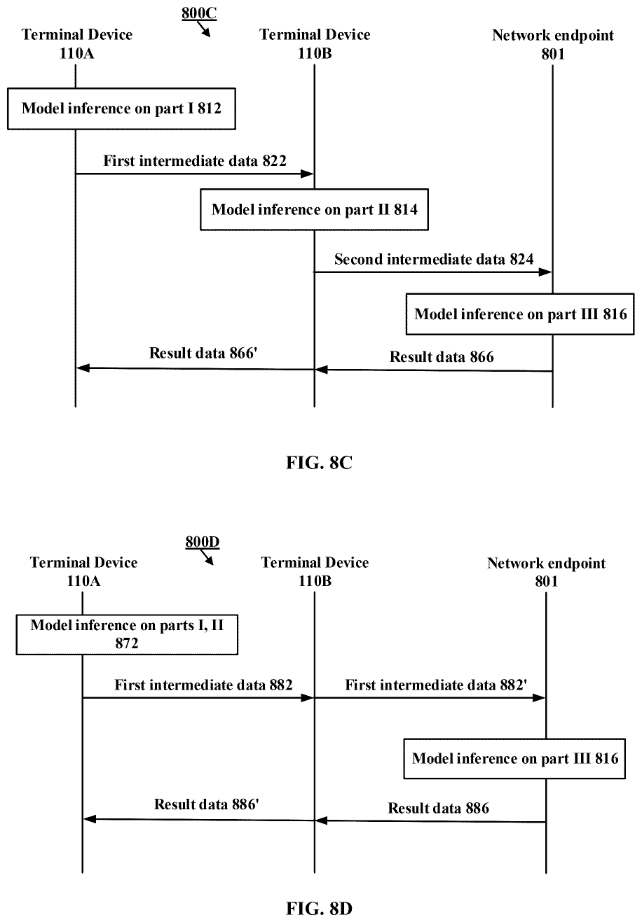

FIG. 8A to FIG. 8D illustrate exemplary operations for performing split model inference according to an embodiment of the present disclosure. The following describes the split model inference operation with reference to the split AI/ML model 200B. In an example operation, the terminal device 110A is a primary participant device of model inference, for example, a corresponding AI/ML task is initiated by the terminal device 110A. Other devices are secondary participant devices for model inference.

As shown in FIG. 8A, the operation 800A includes, at 812, the terminal device 110A performing model inference on a part I. For the part I, when an input value 220 is input, neurons of an input layer 201 receive the corresponding value and propagates the value to neurons of an intermediate layer 202. The neurons of the intermediate layer 202 calculate a weighted sum of output values of the neurons of the input layer 201 and propagate it to neurons of an intermediate layer 203. The neurons of the intermediate layer 203 calculate a weighted sum of the output values of the neurons of the intermediate layer 202, where the weighted sum forms intermediate data 221. At 822, the terminal device 110A transmits the intermediate data 221 to a downstream participant device, i.e., the terminal device 110B.

At 814, the terminal device 110B performs model inference on a part II. Specifically, upon receiving the intermediate data 221, the terminal device 110B provides the intermediate data 221 to the corresponding neurons of the intermediate layer 204 through the neurons of the intermediate layer 203. The neurons of the intermediate layer 204 calculate a weighted sum of the output values of the neurons of the intermediate layer 203, where the weighted sum forms intermediate data 222. At 824, the terminal device 110B transmits the intermediate data 222 to a downstream participant device.

In an embodiment, the downstream participant device is a network endpoint 801 (for example, a base station 120, or a device in the cloud server, the MEC server, or the IDC). That is, for an AI/ML task of the terminal device, the terminal device and the network endpoint jointly perform the model inference, so as to share computation load of the terminal device by using relatively sufficient computation resources on the network endpoint side. In an embodiment, the downstream participant device is another terminal device 110N. That is, for an AI/ML task of a single terminal device, a plurality of terminal devices jointly perform the model inference, so as to share a computation load of the single terminal device only based on computation resources of the plurality of terminal devices.

At 816, the network endpoint 801 or the terminal device 110N performs model inference on the last part III. Specifically, upon receiving the intermediate data 222, the network endpoint 801 or the terminal device 110N provides the intermediate data 222 to corresponding neurons of an intermediate layer 205 respectively through the neurons of the intermediate layer 204. The neurons of the intermediate layer 205 calculate weighted sum of output values of the neurons of the intermediate layer 204 and propagate it to neurons of an output layer 206. The neurons of the output layer 206 calculate a weighted sum of output values of the neurons of the intermediate layer 205, where the weighted sum forms an inference result 240 for the input value 220.

At 826, the network endpoint 801 or the terminal device 110N transmits the inference result 240 to the terminal device 110A. In this way, the terminal device 110A obtains the inference result for the AI/ML task of the terminal device 110A.

In the example of FIG. 8B, the terminal device 110A is a primary participant device for model inference, and the terminal device 110B and the network endpoint 801 are secondary participant devices. Operations in FIG. 8B same as those in FIG. 8A are shown with the same reference numerals and these operations can be understood with reference to the description on FIG. 8A. Only differences between the operation 800B and the operation 800A are described herein. Specifically, after the model inference on a part II is completed, at 844, the intermediate data 222 is transmitted by the terminal device 110B to the terminal device 110A, and at 844′, the terminal device 110A forwards the intermediate data 222 to the network endpoint 801. In this example, the primary participant device performs uplink and downlink communications with the network endpoint 801. This is advantageous if other terminal devices (for example, 110B) have poor uplink communication.

In the example of FIG. 8C, the terminal device 110A is a primary participant device for model inference, and the terminal device 110B and the network endpoint 801 are secondary participant devices. Operations in FIG. 8C same as those in FIG. 8A are shown with the same reference numerals and these operations can be understood with reference to the description on FIG. 8A. Only differences between the operation 800C and the operation 800A are described herein. Specifically, after model inference on a part III is completed, at 866, result data 240 is transmitted by the network endpoint 801 to the terminal device 110B, and at 866′, the terminal device 110B forwards the result data 240 to the terminal device 110A. In this example, the terminal device 110B acting as a secondary participant device performs uplink and downlink communication with the network endpoint 801. This is advantageous if the terminal device 110A acting as the primary participant device has poor uplink and downlink communications.

In the example of FIG. 8D, the terminal device 110A is a primary participant device of model inference, the network endpoint 801 is a secondary participant device, and the terminal device 110B serves as a relay device between the terminal device 110A and the network endpoint 801. Specifically, at 872, the terminal device 110A performs model inference on a part I. At 882, the intermediate data 222 is transmitted by the terminal device 110A to the terminal device 110B, and at 882′, the terminal device 110B forwards the intermediate data 222 to the network endpoint 801. At 816, the network endpoint 801 performs model inference on the part III. At 886, the result data 240 is transmitted by the network endpoint 801 to the terminal device 110B, and at 886′, the terminal device 110B forwards the result data 240 to the terminal device 110A. In this example, the terminal device 110B that does not participate in model inference acts as a relay device between the primary and secondary participant devices. This is advantageous if the terminal device 110A acting as the primary participant device has poor uplink and downlink communications.

FIGS. 8A to 8D illustrate only split model inference operations performed by three participant devices. It should be understood that in the presence of more participant devices, split model inference can be performed in a manner similar to the operations 800A to 800D.

### Examples of Resource Allocation

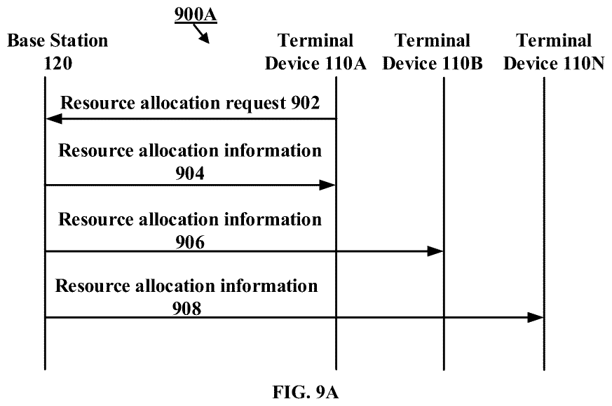

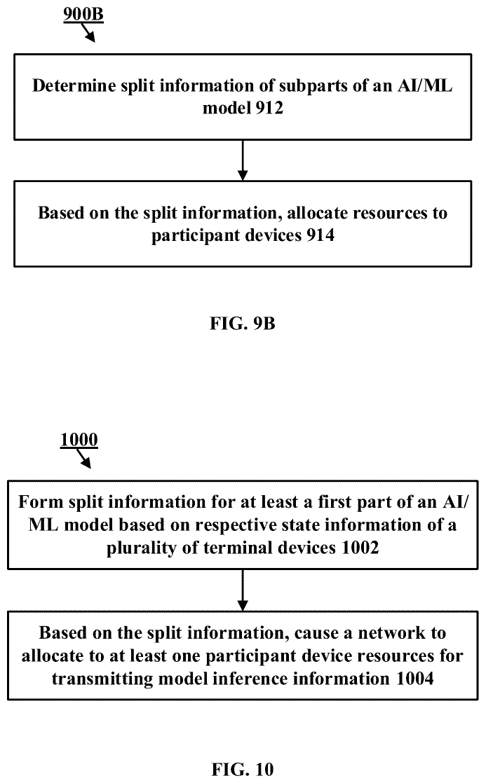

FIG. 9A illustrates an example signaling flow for allocating transmission resources to participant devices of model inference according to an embodiment of the present disclosure. A signaling flow 900A is described with reference to a context similar to that in FIG. 7B, that is, for a split AI/ML model 500B, the terminal device 110A is a primary participant device, and the terminal devices 110B and 110N are secondary participant devices.

As shown in FIG. 9A, the signaling flow 900A includes, at 902, the terminal device 110A transmitting a resource allocation request to the base station 120. In an embodiment, the resource allocation request can include at least split information of the model 500B. For example, the terminal device 110A can indicate a request for transmission resources for each terminal device by providing at least the split information to the base station 120, so as to assist execution of the model inference. Once transmission resources used for each terminal device are determined based on the split information, at 904 to 906, the base station 120 notifies each terminal device of resource allocation information, where the resource allocation information indicates a resource allocation used for at least one of a sidelink, an uplink, or a downlink. In an embodiment, the resource allocation information can be transmitted to each terminal device along with, for example, split information for each participant in FIG. 7B. In an embodiment, the resource allocation request can correspond to or be transmitted along with the inference request at 331 or the split information at 345.

Alternatively or additionally, the base station 120 can allocate transmission resources to the terminal devices 110A to 110N in response to the split information of the model 500B received from another network endpoint or determined by the base station 120 itself.

FIG. 9B illustrates an example operation for allocating transmission resources to participant devices of model inference according to an embodiment of the present disclosure. The example operation 900B can be performed by the base station 120.

As shown in FIG. 9B, the example operation 900B includes, at 912, the base station 120 determining split information of subparts of an AI/ML model (for example, as shown in FIG. 6A, FIG. 6B). In an embodiment, the split information is formed by the base station 120. In an embodiment, the split information is formed by a terminal device (for example, 110A) or another network endpoint (for example, a device in the cloud 140, the MEC 150, or the IDC 160). For example, after forming the split information, the terminal device 110A or another network endpoint transmits a resource allocation request to the base station 120, where the resource allocation request can include the split information.

At 914, the base station 120 allocates, based on the split information, sidelink and/or uplink/downlink transmission resources to the participant devices. Specifically, the base station 120 can determine, based on executor information in the split information, transmission requirements for intermediate data and result data. Taking the three participants in FIG. 8A as an example, based on a service flow formed by the terminal device 110A->the terminal device 110B->the terminal device 110N, transmission requirements of intermediate data and result data can be determined as shown in Table 1. Based on a service flow formed by the terminal device 110A->the terminal device 110B->the base station 120, transmission requirements of intermediate data and result data can be determined as shown in Table 2.

In the example of Table 2, transmission of the intermediate data and result data can involve an uplink and a downlink between a specific terminal device and the base station 120. In a case that a plurality of terminal devices participate in model inference, resources can be allocated to a terminal device with relatively good uplink and downlink communication quality (instead of a specific terminal device) for transmitting respective model inference information, and the model inference information can further be transmitted between intermediate devices via a sidelink. For example, in Table 3, intermediate data generated by the terminal device 110B can be alternatively transmitted by using an uplink between the terminal device 110A and the base station 120. In this way, it can be avoided that communication quality between a single terminal device and the base station 120 is too poor to transmit intermediate data or result data of model inference, resulting a failure of the model inference.

In an embodiment, transmission resources can be allocated to a respective participant device based on an expected output data amount (for example, a data amount within a period of time) of the model inference of a corresponding subpart of the AI/ML model.

Upon completing the resource allocation, the base station 120 can transmit resource allocation information to respective participant devices. For example, the resource allocation information can indicate resource allocation for at least one of a sidelink, an uplink and a downlink. Accordingly, the operations of transmitting the model inference information at 822, 824, and 826 in FIG. 8A can be based on the resource allocation for the sidelink, uplink and/or downlink performed by the base station 120.

TABLE 1

| | | Result data transmission |
|---|---|---|
| Intermediate data transmission requirements | | requirements |
| Sidelink between the terminal | Sidelink between the terminal | Sidelink between the terminal |
| devices 110A and 110B | devices 110B and 110N | devices 110N and 110A |

TABLE 2

| | | Result data transmission |
|---|---|---|
| Intermediate data transmission requirements | | requirements |
| Sidelink between the terminal | Uplink between the terminal | Downlink between the base |
| devices 110A and 110B | device 110B and the base | station 120 and the terminal |
| | station 120 | device 110A |

TABLE 3

| | | Result data transmission |
|---|---|---|
| Intermediate data transmission requirements | | requirements |
| Sidelink between the terminal | Sidelink between the terminal | Downlink between the base |
| devices 110A and 110B | devices 110B and 110A; and | station 120 and the terminal |
| | Uplink between the terminal | device 110A |
| | device 110A and the base | |
| | station 120 | |

### Example Methods

FIG. 10 illustrates an example method for resource allocation in model inference according to an embodiment of the present disclosure. The method can be performed by, for example, the electronic device 300, 310, or 320. As shown in FIG. 10, the method 1000 can include forming split information for at least a first part of an AI/ML model based on respective state information of a first terminal device and one or more other terminal devices (block 1002). The split information specifies that split model inference is to be performed by a plurality of participant devices on a plurality of subparts of at least the first part of the AI/ML model. For example, the AI/ML model is corresponding to an AI/ML task. Additionally, the method 1000 can include determining an AI/ML model corresponding to an AI/ML task of the first terminal device. As shown in FIG. 10, the method 1000 can further include causing, based on the split information, a wireless network to allocate to at least one of the plurality of participant devices resources for transmitting model inference information (block 1004). Further details of the method can be understood with reference to the above descriptions on the electronic devices, terminal devices, or network endpoints.

In an embodiment, the method 1000 further includes: obtaining the respective state information of the first terminal device and the one or more other terminal devices, where the state information is associated with the model inference, and the state information indicates a computation state and/or a communication state of a respective terminal device, the computation state including at least one of a computation resource usage state, a storage resource usage state, or a power level, and the communication state including at least one of a channel quality or a data rate.

In an embodiment, the split information includes indication information for the plurality of subparts and information about participant devices performing model inference, and forming the split information includes: determining the first terminal device and terminal device(s) whose respective states are better than a threshold in the one or more other terminal devices as the plurality of participant devices; and splitting at least the first part of the AI/ML model into the plurality of subparts based on respective state information of the plurality of participant devices.

In an embodiment, the plurality of subparts correspond to the plurality of participant devices, model inference workloads of the plurality of subparts match computation states of respective participant devices, and communication states of the plurality of participant devices are able to support transmission of the model inference information.

In an embodiment, the AI/ML model includes a neural network model, at least the first part of the AI/ML model includes one or more front layers of the AI/ML model, or includes all layers of the AI/ML model; and/or the model inference information includes model inference intermediate data and/or model inference result data.

In an embodiment, causing the wireless network to allocate resources for transmitting the model inference information includes transmitting the split information for at least the first part of the AI/ML model to a base station.

In an embodiment, the method 1000 further includes: transmitting instructions for performing the model inference to respective participant devices based on the split information, the instructions including indication information for a respective subpart of the AI/ML model and indication information for downstream devices.

In an embodiment, the electronic device is implemented as a network endpoint or a part thereof, the network endpoint including a cloud server and/or an edge server.

In an embodiment, the electronic device is implemented as a first terminal device or as part of the first terminal device, and method 1000 further includes: receiving from the base station resource allocation information for the first terminal device, where the resource allocation information indicates resource allocation for at least one of a sidelink, an uplink and a downlink.

In an embodiment, the method 1000 further includes: inputting local data into a first subpart of the AI/ML model to obtain first intermediate data; and providing the first intermediate data to a first participant device via a sidelink with the first participant device, based on resource allocation for the sidelink.

In an embodiment, the method 1000 further includes: receiving, via a sidelink with a second participant device based on resource allocation for the sidelink, second intermediate data output by the second participant device; transmitting the second intermediate data to a network via an uplink, based on resource allocation for the uplink; or receiving an inference result corresponding to the AL/ML model from the network via a downlink, based on resource allocation for the downlink.

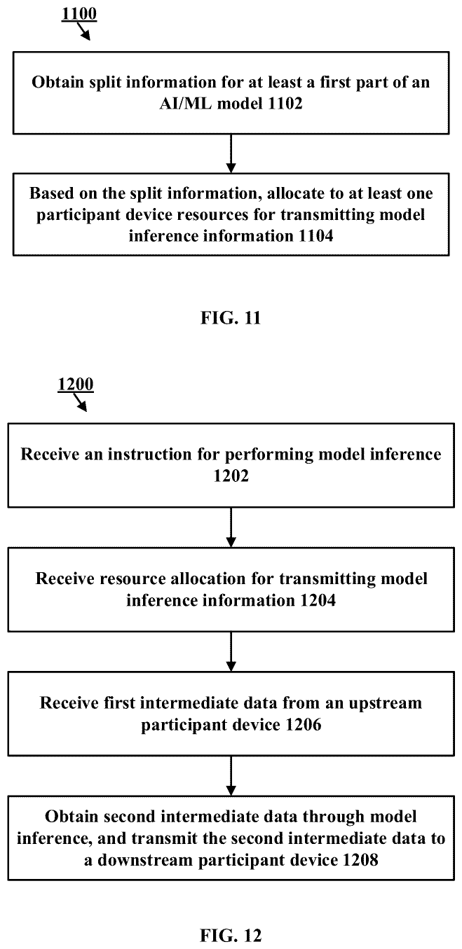

FIG. 11 illustrates an example method for resource allocation in model inference according to an embodiment of the present disclosure. This method can be performed by the electronic device 320. As shown in FIG. 11, the method 1100 can include obtaining split information for at least a first part of an AI/ML model (block 1102). The AI/ML model corresponds to an AI/ML task of a first terminal device, and the split information specifies that split model inference is to be performed by a plurality of participant devices on a plurality of subparts of at least the first part of the AI/ML model. As shown in FIG. 10, the method 1100 can further include, based on the split information, allocating to at least one of the plurality of participant devices resources for transmitting the model inference information (block 1104). Further details of the method can be understood with reference to the above descriptions on the electronic device 320 or the base station.

In an embodiment, the method 1100 further includes: forming the split information based on respective state information of the first terminal device and one or more other terminal devices; or receiving the split information from the first terminal device or a network endpoint.

In an embodiment, the split information includes indication information for the plurality of subparts and information about participant devices performing model inference, and forming the split information includes: determining the first terminal device and terminal device(s) whose respective states are better than a threshold in the one or more other terminal devices as the plurality of participant devices; and splitting at least the first part of the AI/ML model into the plurality of subparts based on respective state information of the plurality of participant devices.

In an embodiment, the plurality of subparts correspond to the plurality of participant devices, model inference workloads of the plurality of subparts match computation states of respective participant devices, and communication states of the plurality of participant devices are able to support transmission of the model inference information.

In an embodiment, the method 1100 further includes: transmitting instructions for performing the model inference to respective participant devices based on the split information, the instructions including indication information for the respective subpart of the AI/ML model and indication information for downstream devices.

In an embodiment, the method 1100 further includes: allocating resources to respective participant devices based on an expected output data volume of model inference of respective subparts of the AI/ML model; and transmitting resource allocation information to respective participant devices, where the resource allocation information indicates resource allocation for at least one of a sidelink, an uplink and a downlink.

FIG. 12 illustrates an example method for performing model inference according to an embodiment of the present disclosure. The method can be performed by the electronic device 310. As shown in FIG. 12, the method 1200 can include receiving an instruction for performing model inference from a first terminal device (block 1202), the instruction including indication information for a respective subpart of an AI/ML model and indication information for a downstream participant device. The method 1200 can further include receiving resource allocation for transmitting model inference information, the resource allocation indicating resources for radio links (for example, including a sidelink) with an upstream participant device and the downstream participant device (block 1204). The method 1200 can further include, based on the instruction and the resource allocation, receiving first intermediate data from the upstream participant device via a radio link with the upstream participant device (block 1206). The method 1200 can further include inputting first intermediate data into the respective subpart of the AI/ML model to obtain second intermediate data; and based on the instruction and the resource allocation, transmitting the second intermediate data to the downstream participant device via a radio link with the downstream participant device (block 1208). Further details of the method can be understood with reference to the above descriptions on the electronic device 310 or the terminal device.

Various exemplary electronic devices and methods according to the embodiments of the present disclosure have been described above. It should be understood that the operations or functions of these electronic devices can be combined with each other to implement more or less operations or functions than described. The operational steps of the methods can also be combined with each other in any suitable order, so that similarly more or fewer operations are implemented than described.

It should be understood that the machine-executable instructions in the machine-readable storage medium or program product according to the embodiments of the present disclosure can be configured to perform operations corresponding to the device and method embodiments described above. When referring to the above device and method embodiments, the embodiments of the machine-readable storage medium or the program product are clear to those skilled in the art, and therefore description thereof will not be repeated herein. A machine-readable storage media and a program product for carrying or including the above-described machine-executable instructions also fall within the scope of the present disclosure. Such storage medium can include, but is not limited to, a floppy disk, an optical disk, a magneto-optical disk, a memory card, a memory stick, and the like. In addition, it should be understood that the above series of processing and devices can alternatively be implemented by software and/or firmware.

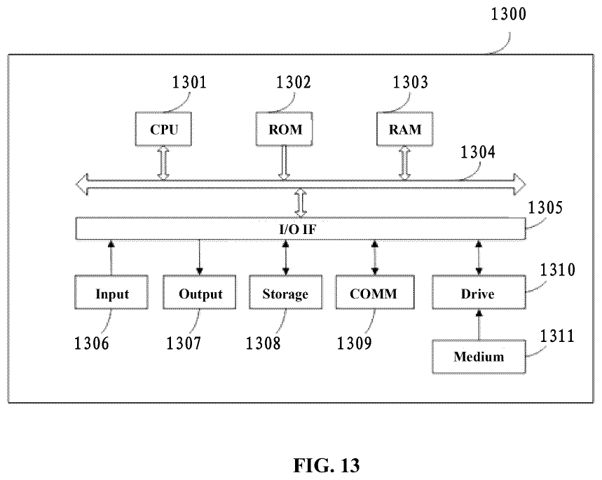

In addition, it should be understood that the above series of processing and devices can alternatively be implemented by software and/or firmware. In addition, it should be understood that the above series of processing and devices can alternatively be implemented by software and/or firmware. In the case of implementation by software and/or firmware, a program constituting the software is installed from a storage medium or a network to a computer having a dedicated hardware configuration, such as a general-purpose computer 1300 shown in FIG. 13. When various programs are installed, the computer is capable of performing various functions and so on. FIG. 13 is an example block diagram of a computer which can be implemented as a terminal device or network endpoint according to an embodiment of the present disclosure.

In FIG. 13, a central processing unit (CPU) 1301 executes various processing based on a program stored in a read-only memory (ROM) 1302 or a program loaded from a storage portion 1308 to a random access memory (RAM) 1303. The RAM 1303 also stores data required for executing various processing and the like by the CPU 1301 when necessary.

The CPU 1301, the ROM 1302, and the RAM 1303 are connected with each other via a bus 1304. An input/output port 1305 is also connected to the bus 1304.

The following components are connected to the input/output port 1305: an input part 1306, including a keyboard, a mouse, and the like; an output part 1307, including a display such as a cathode-ray tube (CRT) and a liquid crystal display (LCD), a speaker, and the like; a storage part 1308, including a hard disk and the like; and a communication part 1309, including a network interface card such as a LAN card or a modem. The communication part 1309 performs communication processing via a network such as the Internet.

Based on needs, a drive 1310 is also connected to the input/output port 1305. A removable medium 1311 such as a magnetic disk, an optical disk, a magneto-optical disk, a semiconductor memory, or the like is mounted on the drive 1310 when necessary, so that a computer program read therefrom is installed in the storage part 1308 when necessary.

In a case that the foregoing series of processing are implemented by software, programs constituting the software are installed from a network such as the Internet or a storage medium such as the removable medium 1311.

Those skilled in the art should understand that such a storage medium is not limited to the removable medium 1311 shown in FIG. 13, in which the program is stored and distributed independent from a device to provide the program for users. For example, the removable medium 1311 includes a magnetic disk (including a floppy disk (registered trademark)), an optical disc (including a compact disk read-only memory (CD-ROM) and a digital versatile disk (DVD)), a magneto-optical disc (including a mini disk (MD) (registered trademark)), and a semiconductor memory. Alternatively, the storage medium can be the ROM 1302, a hard disk included in the storage part 1308, or the like, in which the program is stored, and can be distributed to users along with a device including the storage medium.

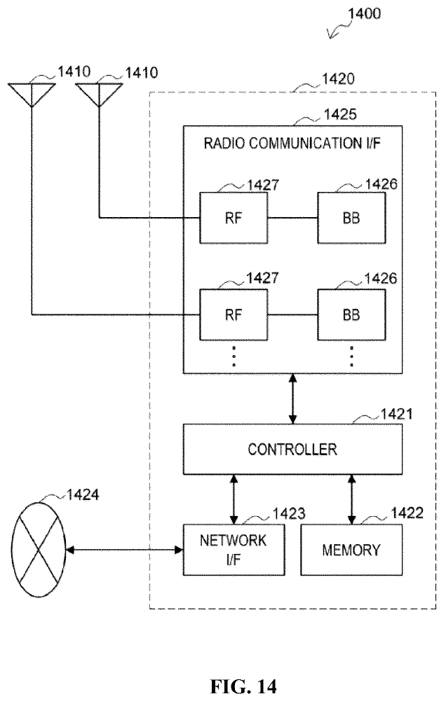

Use cases according to the present disclosure will be described below with reference to FIG. 14 to FIG. 17.

### Use Cases for the Base Station

### First Use Case

FIG. 14 is a block diagram illustrating a first example of a schematic configuration of a gNB to which the technology of the present disclosure can be applied. The gNB 1400 includes a plurality of antennas 1410 and a base station device 1420. The base station device 1420 and each antenna 1410 can be connected to each other via an RF cable. In one implementation, the gNB 1400 (or base station device 1420) herein can correspond to the electronic device 300A described above.

Each of the antennas 1410 includes a single or multiple antenna elements (such as multiple antenna elements included in a multiple input and multiple output (MIMO) antenna), and is used for the base station device 1420 to transmit and receive radio signals. As shown in FIG. 14, the gNB 1400 can include multiple antennas 1410. For example, multiple antennas 1410 can be compatible with multiple frequency bands used by the gNB 1400.

The base station device 1420 includes a controller 1421, a memory 1422, a network interface 1423, and a radio communication interface 1425.

The controller 1421 can be, for example, a CPU or a DSP, and operates various functions of higher layers of the base station device 1420. For example, controller 1421 generates data packets from data in signals processed by the radio communication interface 1425, and transmits the generated packets via the network interface 1423. The controller 1421 can bundle data from multiple baseband processors to generate the bundled packets, and transmit the generated bundled packets. The controller 1421 can have logic functions of performing control such as radio resource control, radio bearer control, mobility management, admission control, and scheduling. This control can be performed in corporation with a gNB or a core network node in the vicinity. The memory 1422 includes a RAM and a ROM, and stores a program that is executed by the controller 1421 and various types of control data (such as a terminal list, transmission power data, and scheduling data).

The network interface 1423 is a communication interface for connecting the base station device 1420 to the core network 1424. The controller 1421 can communicate with a core network node or another gNB via the network interface 1423. In this case, the gNB 1400 and the core network node or other gNBs can be connected to each other through a logical interface (such as an S1 interface and an X2 interface). The network interface 1423 can also be a wired communication interface or a radio communication interface for radio backhaul lines. If the network interface 1423 is a radio communication interface, the network interface 1423 can use a higher frequency band for radio communication than a frequency band used by the radio communication interface 1425.

The radio communication interface 1425 supports any cellular communication schemes (such as Long Term Evolution (LTE) and LTE-Advanced), and provides, via the antenna 1410, radio connection to a terminal located in a cell of the gNB 1400. The radio communication interface 1425 can typically include, for example, a baseband (BB) processor 1426 and a RF circuit 1427. The BB processor 1426 can perform, for example, encoding/decoding, modulation/demodulation, and multiplexing/demultiplexing, and performs various types of signal processing of layers (such as L1, Medium Access Control (MAC), Radio Link Control (RLC), and Packet Data Convergence Protocol (PDCP)). Instead of the controller 1421, the BB processor 1426 can have a part or all of the above-described logic functions. The BB processor 1426 can be a memory that stores a communication control program, or a module that includes a processor configured to execute the program and a related circuit. Updating the program can allow the functions of the BB processor 1426 to be changed. The module can be a card or a blade that is inserted into a slot of the base station device 1420. Alternatively, the module can also be a chip that is mounted on the card or the blade. Meanwhile, the RF circuit 1427 can include, for example, a mixer, a filter, and an amplifier, and transmits and receives radio signals via the antenna 1410. Although FIG. 14 illustrates the example in which one RF circuit 1427 is connected to one antenna 1410, the present disclosure is not limited to thereto; rather, one RF circuit 1427 can connect to a plurality of antennas 1410 at the same time.

As illustrated in FIG. 14, the radio communication interface 1425 can include the multiple BB processors 1426. For example, the multiple BB processors 1426 can be compatible with multiple frequency bands used by gNB 1400. As illustrated in FIG. 14, the radio communication interface 1425 can include the multiple RF circuits 1427. For example, the multiple RF circuits 1427 can be compatible with multiple antenna elements. Although FIG. 14 illustrates the example in which the radio communication interface 1425 includes the multiple BB processors 1426 and the multiple RF circuits 1427, the radio communication interface 1425 can also include a single BB processor 1426 or a single RF circuit 1427.

### Second Use Case

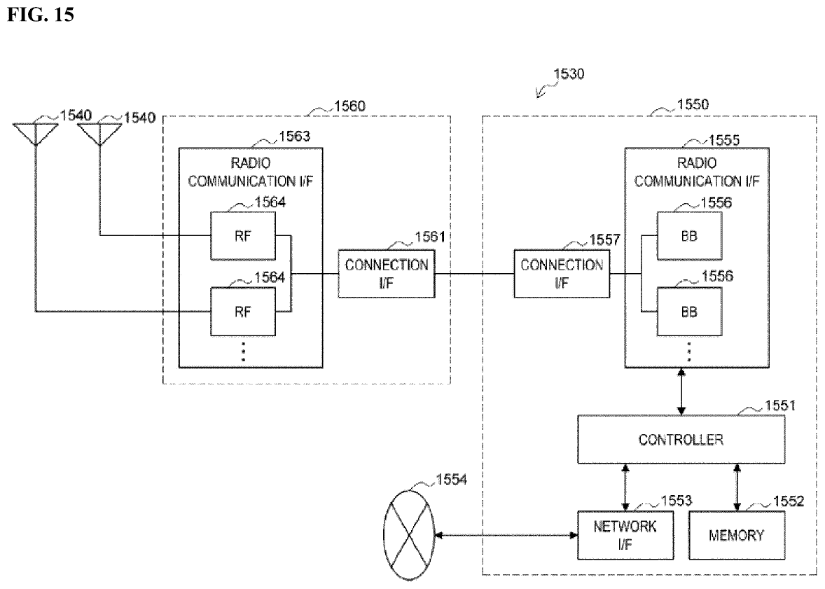

FIG. 15 is a block diagram illustrating a second example of a schematic configuration of a gNB to which the technology of the present disclosure can be applied. The gNB 1530 includes a plurality of antennas 1540, a base station device 1550, and an RRH 1560. The RRH 1560 and each antenna 1540 can be connected to each other via an RF cable. The base station device 1550 and the RRH 1560 can be connected to each other via a high speed line such as a fiber optic cable. In one implementation, the gNB 1530 (or base station device 1550) herein can correspond to the electronic devices 300A described above.

Each of the antennas 1540 includes a single or multiple antenna elements such as multiple antenna elements included in a MIMO antenna and is used for the RRH 1560 to transmit and receive radio signals. As shown in FIG. 15, the gNB 1530 can include multiple antennas 1540. For example, multiple antennas 1540 can be compatible with multiple frequency bands used by the gNB 1530.

The base station device 1550 includes a controller 1551, a memory 1552, a network interface 1553, a radio communication interface 1555, and a connection interface 1557. The controller 1551, the memory 1552, and the network interface 1553 are the same as the controller 1421, the memory 1422, and the network interface 1423 described with reference to FIG. 14.

The radio communication interface 1555 supports any cellular communication scheme (such as LTE and LTE-Advanced) and provides radio communication to terminals positioned in a sector corresponding to the RRH 1560 via the RRH 1560 and the antenna 1540. The radio communication interface 1555 can typically include, for example, a BB processor 1556. The BB processor 1556 is the same as the BB processor 1426 described with reference to FIG. 14, except that the BB processor 1556 is connected to the RF circuit 1564 of the RRH 1560 via the connection interface 1557. As illustrated in FIG. 15, the radio communication interface 1555 can include the multiple BB processors 1556. For example, the multiple BB processors 1556 can be compatible with multiple frequency bands used by gNB 1530. Although FIG. 15 illustrates the example in which the radio communication interface 1555 includes multiple BB processors 1556, the radio communication interface 1555 can also include a single BB processor 1556.

The connection interface 1557 is an interface for connecting the base station device 1550 (radio communication interface 1555) to the RRH 1560. The connection interface 1557 can also be a communication module for communication in the above-described high speed line that connects the base station device 1550 (radio communication interface 1555) to the RRH 1560.

The RRH 1560 includes a connection interface 1561 and a radio communication interface 1563.

The connection interface 1561 is an interface for connecting the RRH 1560 (radio communication interface 1563) to the base station device 1550. The connection interface 1561 can also be a communication module for communication in the above-described high speed line.

The radio communication interface 1563 transmits and receives radio signals via the antenna 1540. The radio communication interface 1563 can typically include, for example, the RF circuitry 1564. The RF circuit 1564 can include, for example, a mixer, a filter, and an amplifier, and transmits and receives radio signals via the antenna 1540. Although FIG. 15 illustrates the example in which one RF circuit 1564 is connected to one antenna 1540, the present disclosure is not limited to thereto; rather, one RF circuit 1564 can connect to a plurality of antennas 1540 at the same time.

As illustrated in FIG. 15, the radio communication interface 1563 can include the multiple RF circuits 1564. For example, the multiple RF circuits 1564 can support multiple antenna elements. Although FIG. 15 illustrates the example in which the radio communication interface 1563 includes the multiple RF circuits 1564, the radio communication interface 1563 can also include a single RF circuit 1564.

### Use Cases for the Terminal Device

### First Use Case

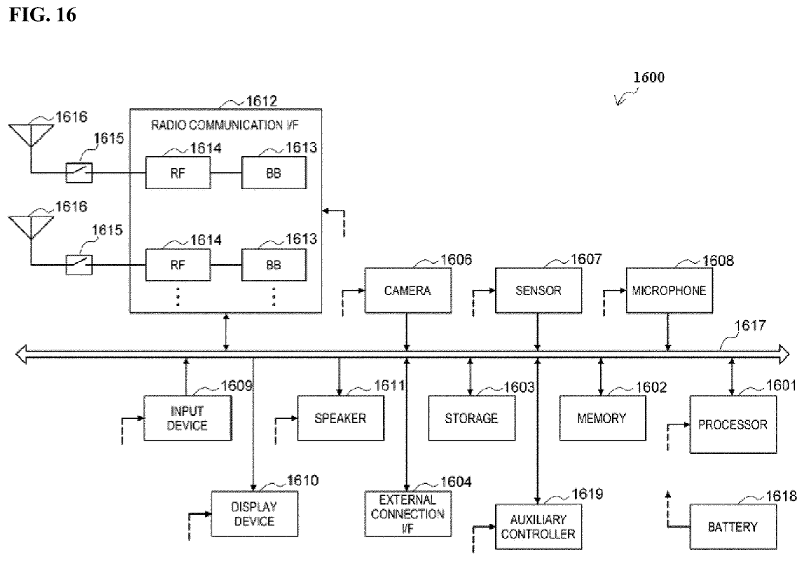

FIG. 16 is a block diagram illustrating an example of a schematic configuration of an smartphone 1600 to which the technology of the present disclosure can be applied. A smartphone 1600 includes a processor 1601, a memory 1602, a storage device 1603, an external connection interface 1604, a camera device 1606, a sensor 1607, a microphone 1608, an input device 1609, a display device 1610, a speaker 1611, a radio communication interface 1612, one or more antenna switches 1615, one or more antennas 1616, a bus 1617, a battery 1618, and an auxiliary controller 1619. In an implementation, the smartphone 1600 (or the processor 1601) herein can correspond to the electronic device 300B.

The processor 1601 can be, for example, a CPU or a system on a chip (SoC), and controls functions of the application layer and other layers of the smartphone 1600. The memory 1602 includes a RAM and a ROM, and stores a program that is executed by the processor 1601. The storage device 1603 can include a storage medium such as a semiconductor memory and a hard disk. The external connection interface 1604 is an interface for connecting an external device (for example, a memory card and a universal serial bus (USB) device) to the smartphone 1600.

The camera device 1606 includes an image sensor (for example, a charge coupled device (CCD) and a complementary metal oxide semiconductor (CMOS)), and generates a captured image. The sensor 1607 can include a set of sensors, such as a measurement sensor, a gyro sensor, a geomagnetic sensor, and an acceleration sensor. The microphone 1608 converts the sound input of the smart phone 1600 into an audio signal. The input device 1609 includes, for example, a touch sensor configured to detect touches on the screen of the display device 1610, a keypad, a keyboard, buttons, or switches, and receives input operations or information of a user. The display device 1610 includes a screen (for example, a liquid crystal display (LCD) and an organic light emitting diode (OLED) display), and displays output images of the smartphone 1600. The speaker 1611 converts output audio signals of the smartphone 1600 into sound.

The radio communication interface 1612 supports any cellular communication scheme (such as LTE, LTE-Advanced) and performs radio communication. The radio communication interface 1612 can typically include, for example, a BB processor 1613 and an RF circuit 1614. The BB processor 1613 can perform, for example, encoding/decoding, modulation/demodulation, and multiplexing/demultiplexing, and performs various types of signal processing for radio communication. Meanwhile, the RF circuit 1614 can include, for example, a mixer, a filter, and an amplifier, and transmits and receives radio signals via the antenna 1616. The radio communication interface 1612 can be a chip module on which the BB processor 1613 and the RF circuit 1614 are integrated. As shown in FIG. 16, the radio communication interface 1612 can include multiple BB processors 1613 and multiple RF circuits 1614. Although FIG. 16 illustrates the example in which the radio communication interface 1612 includes the multiple BB processors 1613 and the multiple RF circuits 1614, the radio communication interface 1612 can also include a single BB processor 1613 or a single RF circuit 1614.

In addition to a cellular communication scheme, the radio communication interface 1612 can support other types of radio communication schemes, such as a short-range wireless communication scheme, a near-field communication scheme, and a wireless local area network (LAN) scheme. In this case, the radio communication interface 1612 can include the BB processor 1613 and the RF circuit 1614 as to each radio communication scheme.

Each of the antenna switches 1615 switches the connection destination of the antenna 1616 among multiple circuits (for example, circuits for different radio communication schemes) included in the radio communication interface 1612.

Each of the antennas 1616 includes one or more antenna elements (such as multiple antenna elements included in a MIMO antenna), and is used for the radio communication interface 1612 to transmit and receive radio signals. As shown in FIG. 16, the smartphone 1600 can include multiple antennas 1616. Although FIG. 16 illustrates an example in which the smartphone 1600 includes multiple antennas 1616, the radio communication interface 1600 can alternatively include a single antenna 1616.

In addition, the smartphone 1600 can include the antennas 1616 for every radio communication scheme. In this case, the antenna switch 1615 can be removed from configuration of the smartphone 1600.

The bus 1617 connects the processor 1601, the memory 1602, the storage device 1603, the external connection interface 1604, the camera device 1606, the sensor 1607, the microphone 1608, the input device 1609, the display device 1610, the speaker 1611, the radio communication interface 1612, and the auxiliary controller 1619. The battery 1618 provides power for various blocks of the smartphone 1600 illustrated in FIG. 16 via feeders, and the feeders are partially expressed as dashed lines in the figure. The auxiliary controller 1619, for example, operates the minimum necessary functions of the smartphone 1600 in sleep mode.

### Second Use Case

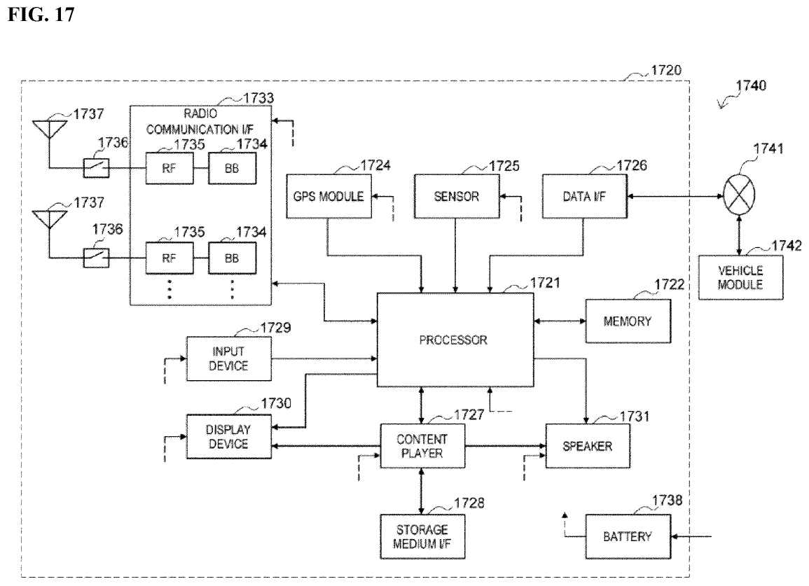

FIG. 17 is a block diagram illustrating an example of a schematic configuration of a car navigation device 1720 to which the technology of the present disclosure can be applied. A car navigation device 1720 includes a processor 1721, a memory 1722, a global positioning system (GPS) 1724, a sensor 1725, a data interface 1726, a content player 1727, a storage medium interface 1728, an input device 1729, a display device 1730, a speaker 1731, a radio communication interface 1733, one or more antenna switches 1736, one or more antennas 1737, and a battery 1738. In an implementation, the car navigation device 1720 (or the processor 1721) herein can correspond to the electronic device 300B.

The processor 1721 can be, for example, a CPU or a SoC, and controls the navigation function and other functions of the car navigation device 1720. The memory 1722 includes a RAM and a ROM, and stores a program that is executed by the processor 1721.

The GPS module 1724 performs measurement on a location (such as a latitude, a longitude, and an altitude) of the car navigation device 1720 by using GPS signals received from GPS satellites. The sensor 1725 can include a set of sensors, such as a gyro sensor, a geomagnetic sensor, and an air pressure sensor. The data interface 1726 is connected to, for example, an in-vehicle network 1741 via a terminal not shown, and acquires data generated by the vehicle (such as vehicle speed data).

The content player 1727 plays back content stored in a storage medium (such as a CD and a DVD), which is inserted into the storage medium interface 1728. The input device 1729 includes, for example, a touch sensor configured to detect touches on the screen of the display device 1730, buttons, or switches, and receives input operations or information of a user. The display device 1730 includes a screen, for example, an LCD or OLED screen, and displays images for the navigation function or playback content. The speaker 1731 outputs the sound for the navigation function or playback content.

The radio communication interface 1733 supports any cellular communication scheme (such as LTE, LTE-Advanced, and NR) and performs radio communication. The radio communication interface 1733 can typically include, for example, a BB processor 1734 and an RF circuit 1735. The BB processor 1734 can perform, for example, encoding/decoding, modulation/demodulation, and multiplexing/demultiplexing, and performs various types of signal processing for radio communication. Meanwhile, the RF circuit 1735 can include, for example, a mixer, a filter, and an amplifier, and transmits and receives radio signals via the antenna 1737. The radio communication interface 1733 can alternatively be a chip module on which the BB processor 1734 and the RF circuit 1735 are integrated. As shown in FIG. 17, the radio communication interface 1733 can include multiple BB processors 1734 and multiple RF circuits 1735. Although FIG. 17 illustrates the example in which the radio communication interface 1733 includes the multiple BB processors 1734 and the multiple RF circuits 1735, the radio communication interface 1733 can also include a single BB processor 1734 or a single RF circuit 1735.

In addition to a cellular communication scheme, the radio communication interface 1733 can support other types of radio communication schemes, such as a short-range wireless communication scheme, a near-field communication scheme, and a wireless LAN scheme. In this case, the radio communication interface 1733 can include the BB processor 1734 and the RF circuit 1735 as to each radio communication scheme.

Each of the antenna switches 1736 switches the connection destination of the antenna 1737 among multiple circuits (for example, circuits for different radio communication schemes) included in the radio communication interface 1733.

Each of the antennas 1737 includes one or more antenna elements (such as multiple antenna elements included in a MIMO antenna), and is used for the radio communication interface 1733 to transmit and receive radio signals. As shown in FIG. 17, the car navigation device 1720 can include multiple antennas 1737. Although FIG. 17 illustrates an example in which the car navigation device 1720 includes multiple antennas 1737, the car navigation device 1720 can alternatively include a single antenna 1737.

In addition, the car navigation device 1720 can include the antenna 1737 for every radio communication scheme. In this case, the antenna switch 1736 can be removed from configuration of the car navigation device 1720.

The battery 1738 provides power for various blocks of the car navigation device 1720 illustrated in FIG. 17 via feeders, and the feeders are partially expressed as dashed lines in the figure. The battery 1738 accumulates power supplied by the vehicle.

The technology of the present disclosure can also be implemented as an in-vehicle system (or vehicle) 1740 including one or more blocks of the car navigation device 1720, the in-vehicle network 1741, and a vehicle module 1742. The vehicle module 1742 generates vehicle data (such as vehicle speed, engine speed, and failure information), and outputs the generated data to the in-vehicle network 1741.

It should be understood that the technical solutions of the present disclosure can be implemented in the following example implementations.

1. An electronic device, including a processing circuit configured to:
determine an AI/ML model corresponding to an AI/ML task of a first terminal device;
form split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and
based on the split information, cause a wireless network to allocate to at least one of the plurality of participant devices resources for transmitting model inference information.

2. The electronic device according to item 1, where the processing circuit is further configured to: obtain the respective state information of the first terminal device and the one or more other terminal devices, where the state information is associated with the model inference, and
where the state information indicates a computation state and/or a communication state of a respective terminal device, the computation state including at least one of a computation resource usage state, a storage resource usage state, or a power level, and the communication state including at least one of a channel quality or a data rate.

3. The electronic device according to item 2, where the split information includes indication information for the plurality of subparts and information about participant devices to perform model inference, and forming the split information includes:
determining the first terminal device and terminal device(s) whose respective states are better than a threshold in the one or more other terminal devices as the plurality of participant devices; and
splitting at least the first part of the AI/ML model into the plurality of subparts based on respective state information of the plurality of participant devices.

4. The electronic device according to item 3, where the plurality of subparts correspond to the plurality of participant devices, model inference workloads of the plurality of subparts match computation states of respective participant devices, and communication states of the plurality of participant devices are able to support transmission of the model inference information.

5. The electronic device according to item 1, where the AI/ML model includes a neural network model, at least the first part of the AI/ML model includes one or more front layers of the AI/ML model, or includes all layers of the AI/ML model; and/or
the model inference information includes model inference intermediate data and/or model inference result data.

6. The electronic device according to item 4, where causing the wireless network to allocate resources for transmitting the model inference information includes transmitting the split information for at least the first part of the AI/ML model to a base station.

7. The electronic device according to item 6, where the processing circuit is further configured to:
transmit instructions for performing the model inference to respective participant devices based on the split information, the instructions including indication information for respective subparts of the AI/ML model and indication information for a downstream device.

8. The electronic device according to item 7, where the electronic device is implemented as a network endpoint or a part thereof, the network endpoint including a cloud server and/or an edge server.

9. The electronic device according to item 7, where the electronic device is implemented as the first terminal device or a part thereof, and where the processing circuit is further configured to:
receive from the base station resource allocation information for the first terminal device, where the resource allocation information indicates resource allocation for at least one of a sidelink, an uplink and a downlink; or
based on the split information, allocate to at least one of the plurality of participant devices a sidelink resource for transmitting the model inference information.

10. The electronic device according to item 9, where the processing circuit is further configured to:
input local data into a first subpart of the AI/ML model to obtain first intermediate data; and
provide the first intermediate data to a first participant device via a sidelink with the first participant device, based on resource allocation for the sidelink.

11. The electronic device according to item 9, where the processing circuit is further configured to:
transmit the first intermediate data to a second participant device via a sidelink with the second participant device, based on resource allocation for the sidelink;
receive, via a sidelink with a second participant device, second intermediate data output by the second participant device, based on resource allocation for the sidelink;
transmit the second intermediate data to a network via an uplink, based on resource allocation for the uplink;
receive an inference result forwarded by the second participant device, via the sidelink with the second participant device, based on resource allocation for the sidelink; and
receive an inference result corresponding to the AL/ML model from the network via a downlink, based on resource allocation for the downlink.

12. An electronic device for a base station, including a processing circuit configured to:
obtain split information for at least a first part of an AI/ML model, where the AI/ML model corresponds to an AI/ML task of a first terminal device, and the split information specifies that split model inference is to be performed by a plurality of participant devices on a plurality of subparts of at least the first part of the AI/ML model; and
based on the split information, allocate to at least one of the plurality of participant devices resources for transmitting model inference information.

13. The electronic device according to item 12, where the processing circuit is further configured to:
form the split information based on respective state information of the first terminal device and one or more other terminal devices; or receive the split information from the first terminal device or a network endpoint.

14. The electronic device according to item 13, where the split information includes indication information for the plurality of subparts and information about participant devices to perform model inference, and forming the split information includes:
determining the first terminal device and terminal device(s) whose respective states are better than a threshold in the one or more other terminal devices as the plurality of participant devices; and
splitting at least the first part of the AI/ML model into the plurality of subparts based on respective state information of the plurality of participant devices.

15. The electronic device according to item 14, where the plurality of subparts correspond to the plurality of participant devices, model inference workloads of the plurality of subparts match computation states of respective participant devices, and communication states of the plurality of participant devices are able to support transmission of the model inference information.

16. The electronic device according to item 13, where the processing circuit is further configured to:
transmit instructions for performing the model inference to respective participant devices based on the split information, the instructions including indication information for respective subparts of the AI/ML model and indication information for a downstream device.

17. The electronic device according to item 16, where the processing circuit is further configured to:
allocate resources to respective participant devices based on an expected output data volume of model inference of respective subparts of the AI/ML model; and
transmit resource allocation information to respective participant devices, where the resource allocation information indicates resource allocation for at least one of a sidelink, an uplink and a downlink.

18. An electronic device for a second terminal device, including a processing circuit configured to:
receive an instruction for performing model inference from a first terminal device, the instruction including indication information for a respective subpart of an AI/ML model and indication information for a downstream participant device;
receive resource allocation for transmitting model inference information, the resource allocation indicating resources for radio links with an upstream participant device and the downstream participant device;
based on the instruction and the resource allocation, receive first intermediate data from the upstream participant device via the radio link with the upstream participant device;
input first intermediate data into the respective subpart of the AI/ML model to obtain second intermediate data; and
based on the instruction and the resource allocation, transmit second intermediate data to the downstream participant device via the radio link with the downstream participant device.

19. A method for model inference in a wireless communication system, including:
determining an AI/ML model corresponding to an AI/ML task of a first terminal device;
forming split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and
based on the split information, causing a wireless network to allocate to at least one of the plurality of participant devices resources for transmitting model inference information.

20. A method for model inference in a wireless communication system, including:
obtaining split information for at least a first part of an AI/ML model, where the AI/ML model corresponds to an AI/ML task of a first terminal device, and the split information specifies that split model inference is to be performed by a plurality of participant devices on a plurality of subparts of at least the first part of the AI/ML model; and
based on the split information, allocating to at least one of the plurality of participant devices resources for transmitting the model inference information.

21. A method for model inference in a wireless communication system, including by a second terminal device:
receiving an instruction for performing model inference from a first terminal device, the instruction including indication information for a respective subpart of an AI/ML model and indication information for a downstream participant device;
receiving resource allocation for transmitting model inference information, the resource allocation indicating resources for radio links with an upstream participant device and the downstream participant device;
based on the instruction and the resource allocation, receiving first intermediate data from the upstream participant device via the radio link with the upstream participant device;
inputting first intermediate data into the respective subpart of the AI/ML model to obtain second intermediate data; and
based on the instruction and the resource allocation, transmitting second intermediate data to the downstream participant device via the radio link with the downstream participant device.

22. A computer program product including instructions which, when executed by a processor, cause implementation of the method according to any one of items 19 to 21.

The exemplary embodiments of the present disclosure have been described above with reference to the drawings, while the present disclosure is of course not limited to the above examples. Those skilled in the art can obtain various changes and modifications within the scope of the appended claims, and it should be understood that these changes and modifications will naturally fall within the technical scope of the present disclosure.

For example, a plurality of functions included in one unit in the above embodiments can be implemented by separate devices. Alternatively, the multiple functions implemented by the multiple units in the above embodiments can be implemented by separate devices, respectively. In addition, one of the above functions can be realized by multiple units. Needless to say, such a configuration is included in the technical scope of the present disclosure.

In this specification, the steps described in the flowchart include not only processes performed in time series in the described order, but also processes performed in parallel or individually and not necessarily in time series. In addition, even in the steps processed in time series, needless to say, the order can be changed appropriately.

Although the present disclosure and its advantages have been described in detail, it should be understood that various modifications, replacements, and changes can be made without departing from the spirit and scope of the present disclosure as defined by the appended claims. Moreover, the terms “include” and “comprise”, or any of their variants in the embodiments of the present disclosure are intended to cover a non-exclusive inclusion, so that a process, method, article, or device that includes a list of elements not only includes those elements but also includes other elements that are not expressly listed, or further includes elements inherent to such process, method, article, or device. In absence of more constraints, an element preceded by “includes a . . . ” does not preclude existence of other identical elements in the process, method, article, or device that includes the element.

1. An electronic device, comprising a processing circuit configured to:
determine an AI/ML model corresponding to an AI/ML task of a first terminal device;
form split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and
based on the split information, cause a wireless network to allocate to at least one of the plurality of participant devices resources for transmitting model inference information.

2. The electronic device according to claim 1, wherein the processing circuit is further configured to: obtain the respective state information of the first terminal device and the one or more other terminal devices, wherein the state information is associated with the model inference, and
wherein the state information indicates a computation state and/or a communication state of a respective terminal device, the computation state comprising at least one of a computation resource usage state, a storage resource usage state, or a power level, and the communication state comprising at least one of a channel quality or a data rate.

3. The electronic device according to claim 2, wherein the split information comprises indication information for the plurality of subparts and information about participant devices to perform model inference, and forming the split information comprises:
determining the first terminal device and terminal device(s) whose respective states are better than a threshold in the one or more other terminal devices as the plurality of participant devices; and
splitting at least the first part of the AI/ML model into the plurality of subparts based on respective state information of the plurality of participant devices.

4. The electronic device according to claim 3, wherein the plurality of subparts correspond to the plurality of participant devices, model inference workloads of the plurality of subparts match computation states of respective participant devices, and communication states of the plurality of participant devices are able to support transmission of the model inference information.

5. The electronic device according to claim 1, wherein
the AI/ML model comprises a neural network model, at least the first part of the AI/ML model comprises one or more front layers of the AI/ML model, or comprises all layers of the AI/ML model; and/or
the model inference information comprises model inference intermediate data and/or model inference result data.

6. The electronic device according to claim 4, wherein causing the wireless network to allocate resources for transmitting the model inference information comprises transmitting the split information for at least the first part of the AI/ML model to a base station.

7. The electronic device according to claim 6, wherein the processing circuit is further configured to:
transmit instructions for performing the model inference to respective participant devices based on the split information, the instructions comprising indication information for respective subparts of the AI/ML model and indication information for a downstream device.

8. The electronic device according to claim 7, wherein the electronic device is implemented as a network endpoint or a part thereof, the network endpoint comprising a cloud server and/or an edge server.

9. The electronic device according to claim 7, wherein the electronic device is implemented as the first terminal device or a part thereof, and wherein the processing circuit is further configured to:
receive from the base station resource allocation information for the first terminal device, wherein the resource allocation information indicates resource allocation for at least one of a sidelink, an uplink and a downlink; or
based on the split information, allocate to at least one of the plurality of participant devices a sidelink resource for transmitting the model inference information.

10. The electronic device according to claim 9, wherein the processing circuit is further configured to:
input local data into a first subpart of the AI/ML model to obtain first intermediate data; and
provide the first intermediate data to a first participant device via a sidelink with the first participant device, based on resource allocation for the sidelink.

11. The electronic device according to claim 9, wherein the processing circuit is further configured to:
transmit the first intermediate data to a second participant device via a sidelink with the second participant device, based on resource allocation for the sidelink;
receive, via a sidelink with a second participant device, second intermediate data output by the second participant device, based on resource allocation for the sidelink;
transmit the second intermediate data to a network via an uplink, based on resource allocation for the uplink;
receive an inference result forwarded by the second participant device, via the sidelink with the second participant device, based on resource allocation for the sidelink; and
receive an inference result corresponding to the AL/ML model from the network via a downlink, based on resource allocation for the downlink.

12. An electronic device for a base station, comprising a processing circuit configured to:
obtain split information for at least a first part of an AI/ML model, wherein the AI/ML model corresponds to an AI/ML task of a first terminal device, and the split information specifies that split model inference is to be performed by a plurality of participant devices on a plurality of subparts of at least the first part of the AI/ML model; and
based on the split information, allocate to at least one of the plurality of participant devices resources for transmitting model inference information.

13. The electronic device according to claim 12, wherein the processing circuit is further configured to:
form the split information based on respective state information of the first terminal device and one or more other terminal devices; or
receive the split information from the first terminal device or a network endpoint.

14. The electronic device according to claim 13, wherein the split information comprises indication information for the plurality of subparts and information about participant devices to perform model inference, and forming the split information comprises:
determining the first terminal device and terminal device(s) whose respective states are better than a threshold in the one or more other terminal devices as the plurality of participant devices; and
splitting at least the first part of the AI/ML model into the plurality of subparts based on respective state information of the plurality of participant devices.

15. The electronic device according to claim 14, wherein the plurality of subparts correspond to the plurality of participant devices, model inference workloads of the plurality of subparts match computation states of respective participant devices, and communication states of the plurality of participant devices are able to support transmission of the model inference information.

16. The electronic device according to claim 13, wherein the processing circuit is further configured to:
transmit instructions for performing the model inference to respective participant devices based on the split information, the instructions comprising indication information for respective subparts of the AI/ML model and indication information for a downstream device.

17. The electronic device according to claim 16, wherein the processing circuit is further configured to:
allocate resources to respective participant devices based on an expected output data volume of model inference of respective subparts of the AI/ML model; and
transmit resource allocation information to respective participant devices, wherein the resource allocation information indicates resource allocation for at least one of a sidelink, an uplink and a downlink.

18. An electronic device for a second terminal device, comprising a processing circuit configured to:
receive an instruction for performing model inference from a first terminal device, the instruction comprising indication information for a respective subpart of an AI/ML model and indication information for a downstream participant device;
receive resource allocation for transmitting model inference information, the resource allocation indicating resources for radio links with an upstream participant device and the downstream participant device;
based on the instruction and the resource allocation, receive first intermediate data from the upstream participant device via the radio link with the upstream participant device;
input first intermediate data into the respective subpart of the AI/ML model to obtain second intermediate data; and
based on the instruction and the resource allocation, transmit second intermediate data to the downstream participant device via the radio link with the downstream participant device.

19. A method for model inference in a wireless communication system, comprising:
determining an AI/ML model corresponding to an AI/ML task of a first terminal device;
forming split information for at least a first part of the AI/ML model based on respective state information of the first terminal device and one or more other terminal devices, the split information specifying that split model inference is to be performed by a plurality of participant devices on a plurality of subparts of at least the first part of the AI/ML model; and
based on the split information, causing a wireless network to allocate to at least one of the plurality of participant devices resources for transmitting model inference information.

20. (canceled)

21. A method for model inference in a wireless communication system, comprising by a second terminal device:
receiving an instruction for performing model inference from a first terminal device, the instruction comprising indication information for a respective subpart of an AI/ML model and indication information for a downstream participant device;
receiving resource allocation for transmitting model inference information, the resource allocation indicating resources for radio links with an upstream participant device and the downstream participant device;
based on the instruction and the resource allocation, receiving first intermediate data from the upstream participant device via the radio link with the upstream participant device;
inputting first intermediate data into the respective subpart of the AI/ML model to obtain second intermediate data; and
based on the instruction and the resource allocation, transmitting second intermediate data to the downstream participant device via the radio link with the downstream participant device.

22. (canceled)
